(19) United States
(12) Patent Application Publication
(10) Pub. No.: US 2026/0213898 A1
(43) Pub. Date: Jul. 23, 2026

(54) SCHEDULING MULTIPLE DATA MESSAGES WITH LIGHT ADAPTATION BETWEEN SUBBANDS OF AN ACTIVE BANDWIDTH PART USING A SINGLE DOWNLINK CONTROL INFORMATION MESSAGE

(71) Applicant: QUALCOMM Incorporated, San Diego, CA (US)

(72) Inventors: Diana MAAMARI, San Diego, CA (US); Gabi SARKIS, San Diego, CA (US); Mostafa KHOSHNEVISAN, San Diego, CA (US)

(21) Appl. No.: 19/034,893

(22) Filed: Jan. 23, 2025

(51) Int. Cl. H04L 5/00; H04L 27/26; H04W 72/0457; H04W 72/23

(52) U.S. Cl. CPC H04L 5/0048; H04L 5/0094; H04L 27/26538; H04W 72/0457; H04W 72/23

(57) ABSTRACT

Methods, systems, and devices for wireless communication are described. Various aspects generally relate to scheduling multiple data messages with light adaptation between subbands of an active bandwidth part (BWP) using a single downlink control information (DCI) message. Some aspects more specifically relate to one or more signaling- or configuration-based mechanisms according to which a user equipment (UE) and a network entity may use a single DCI message to schedule multiple data messages in systems in which an active BWP includes multiple subbands, each subband associated with different valid quantities of physical resource blocks (PRBs). In some aspects, the DCI message may include an explicit indication of which subband the UE is to use to communicate each data message of the multiple data messages. In some other aspects, the DCI message may implicitly indicate which subband the UE is to use to communicate each data message of the multiple data messages.

### FIELD OF TECHNOLOGY

The following relates to wireless communications, including scheduling multiple data messages with light adaptation between subbands of an active bandwidth part (BWP) using a single downlink control information (DCI) message.

### BACKGROUND

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communication systems, a UE may support multiple bandwidth parts (BWPs) and may communicate with a base station via an active BWP of the multiple BWPs. Each BWP of the multiple BWPs may be associated with a respective set of configured parameters such that, in some cases, the UE may use a first set of configured parameters in accordance with communicating via a first BWP and may use a second set of configured parameters in accordance with communicating via a second BWP. Switching between BWPs may be associated with a corresponding switch between sets of configured parameters, which may involve a relatively “heavy” reconfiguration at the UE.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus for wireless communication at a user equipment (UE). The apparatus may include a processing system that includes processor circuitry and memory circuitry that stores code. The processing system may be configured to cause the apparatus to receive first configuration information indicative of a set of parameters associated with an active bandwidth part of the UE and, as part of the first configuration information, second configuration information indicative of a set of multiple subbands within the active bandwidth part, the set of multiple subbands including different valid quantities of physical resource blocks (PRBs), receive a downlink control information (DCI) message that includes resource allocation information associated with a set of multiple data messages and includes subband information indicative of which subband of the set of multiple subbands the UE is to use to communicate each data message of the set of multiple data messages, and communicate the set of multiple data messages using at least one subband of the set of multiple subbands in accordance with the resource allocation information and the subband information.

Another innovative aspect of the subject matter described in this disclosure can be implemented in a method for wireless communication by or at a UE. The method may include receiving first configuration information indicative of a set of parameters associated with an active bandwidth part of the UE and, as part of the first configuration information, second configuration information indicative of a set of multiple subbands within the active bandwidth part, the set of multiple subbands including different valid quantities of PRBs, receiving a DCI message that includes resource allocation information associated with a set of multiple data messages and includes subband information indicative of which subband of the set of multiple subbands the UE is to use to communicate each data message of the set of multiple data messages, and communicating the set of multiple data messages using at least one subband of the set of multiple subbands in accordance with the resource allocation information and the subband information.

Another innovative aspect of the subject matter described in this disclosure can be implemented in an apparatus for wireless communication at a UE. The apparatus may include means for receiving first configuration information indicative of a set of parameters associated with an active bandwidth part of the UE and, as part of the first configuration information, second configuration information indicative of a set of multiple subbands within the active bandwidth part, the set of multiple subbands including different valid quantities of PRBs, means for receiving a DCI message that includes resource allocation information associated with a set of multiple data messages and includes subband information indicative of which subband of the set of multiple subbands the UE is to use to communicate each data message of the set of multiple data messages, and means for communicating the set of multiple data messages using at least one subband of the set of multiple subbands in accordance with the resource allocation information and the subband information.

Some examples of the method, UEs, apparatuses, and non-transitory computer-readable medium described herein may further include operations, features, means, or instructions for transmitting an indication of a subband switching time associated with the set of multiple subbands, the resource allocation information associated with the set of multiple data messages being in accordance with the subband switching time. In some examples of the method, UEs, apparatuses, and non-transitory computer-readable medium described herein, the subband switching time may be associated with a capability of the UE.

In some examples of the method, UEs, apparatuses, and non-transitory computer-readable medium described herein, the subband information includes a bitmap and each bit of the bitmap corresponds to a respective data message of the set of multiple data messages and indicates which subband of the set of multiple subbands the UE may be to use to communicate the respective data message.

In some examples of the method, UEs, apparatuses, and non-transitory computer-readable medium described herein, the subband information includes a field and different codepoints of the field indicate different subband patterns the UE may be to use to communicate the set of multiple data messages.

In some examples of the method, UEs, apparatuses, and non-transitory computer-readable medium described herein, the subband information includes a subband identifier (ID) and the subband ID indicates which subband of the set of multiple subbands the UE may be to use to communicate the set of multiple data messages.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system including user equipments (UEs) and network entities that supports scheduling multiple data messages with light adaptation between subbands of an active bandwidth part (BWP) using a single downlink control information (DCI) message.

FIG. 2 shows an example of a subband configuration, of multiple subbands within an active BWP, that supports scheduling multiple data messages with light adaptation between subbands of an active BWP using a single DCI message.

FIGS. 3A, 3B, and 4 show examples of communication timelines in which a DCI message schedules a data message in accordance with light adaptation between subbands of an active BWP.

FIG. 5 shows an example of a signaling diagram between a UE and a network entity that supports scheduling multiple data messages with light adaptation between subbands of an active BWP using a single DCI message.

FIGS. 6A, 6B, 7A, and 7B show examples of subband information designs that support scheduling multiple data messages with light adaptation between subbands of an active BWP using a single DCI message.

FIG. 8 shows an example of a communication timeline in which a single DCI message schedules multiple data messages with light adaptation between subbands and with a sufficient subband switching time for a subband switch.

FIG. 9 shows an example of a communication timeline in which a single DCI message schedules multiple data messages with light adaptation between subbands and without a subband switching time for a subband switch.

FIG. 10 shows an example of a process flow illustrative of signaling between a UE and a network entity that supports scheduling multiple data messages with light adaptation between subbands of an active BWP using a single DCI message.

FIGS. 11 and 12 show block diagrams of devices that support scheduling multiple data messages with light adaptation between subbands of an active BWP using a single DCI message.

FIG. 13 shows a block diagram of a communications manager that supports scheduling multiple data messages with light adaptation between subbands of an active BWP using a single DCI message.

FIG. 14 shows a diagram of a system including a device that supports scheduling multiple data messages with light adaptation between subbands of an active BWP using a single DCI message.

FIGS. 15 and 16 show block diagrams of devices that support scheduling multiple data messages with light adaptation between subbands of an active BWP using a single DCI message.

FIG. 17 shows a block diagram of a communications manager that supports scheduling multiple data messages with light adaptation between subbands of an active BWP using a single DCI message.

FIG. 18 shows a diagram of a system including a device that supports scheduling multiple data messages with light adaptation between subbands of an active BWP using a single DCI message.

FIGS. 19-22 show flowcharts illustrating methods that support scheduling multiple data messages with light adaptation between subbands of an active BWP using a single DCI message.

### DETAILED DESCRIPTION

In some wireless communication systems, a user equipment (UE) may support multiple bandwidth parts (BWPs) and may communicate with a network entity via an active BWP of the multiple BWPs. Each of the multiple BWPs that a UE supports may be associated with a respective set of configured parameters such that, in some cases, the UE may use a first set of configured parameters in accordance with communicating via a first BWP and may use a second set of configured parameters in accordance with communicating via a second BWP. For example, some parameters may be configured on a per-BWP basis. Switching between BWPs may be associated with a corresponding switch between sets of configured parameters, which may involve a relatively “heavy” reconfiguration at the UE. Such a “heavy” reconfiguration may be associated with a relatively high cost at the UE to store the respective sets of configured parameters for each BWP or a relatively long timeline for the UE to reconfigure parameters each time a BWP switch occurs.

To mitigate such reconfiguration costs associated with BWP switches, some systems may support a light bandwidth adaptation mechanism according to which a network entity may configure multiple subbands within a BWP, with the multiple subbands inheriting some of the parameters configured for the BWP and with each of the multiple subbands being configured with relatively smaller sets of subband-specific parameters. Such multiple subbands may be referred to or understood as multiple sub-BWPs within a BWP. In accordance with each of the multiple subbands being configured with relatively smaller sets of subband-specific parameters and otherwise being associated with the same parameters as the larger BWP, switching between subbands may involve a relatively “light” adaptation at a UE. A set of subband-specific parameters may be referred to or understood as a limited sub-BWP configuration. Some examples of a limited sub-BWP configuration may include a configuration of a maximum schedulable bandwidth, a maximum rank of transmission, or a maximum K0/K2 value. For example, a subband-specific parameter may include bandwidth such that, for example, different subbands may be associated with (may include) different valid quantities of physical resource blocks (PRBs), resource blocks (RBs), or physical resource block groups (RBGs). Such variation in valid quantities of PRBs across different subbands may result in ambiguous parsing of some DCI messages, such as a DCI message that schedules multiple data messages (with some of the data messages being scheduled over the first subband or sub-BWP and some other of the data messages being scheduled over the second subband or sub-BWP). For example, some DCI formats may lack a mechanism associated with indicating which subbands to use to communicate each of multiple scheduled data messages, which may lead to ambiguity regarding which subband to use to communicate the multiple data messages.

Various aspects generally relate to scheduling multiple data messages with light adaptation between subbands of an active BWP using a single DCI message. Some aspects more specifically relate to one or more signaling- or configuration-based mechanisms according to which a UE and a network entity may use a single DCI message to schedule multiple data messages in systems in which an active BWP includes multiple subbands or sub-BWP configurations, each subband or sub-BWP associated with different valid quantities of PRBs. For example, two subband or sub-BWP configurations may be provided where a first valid quantity of RBs is 270 RBs and a second valid quantity of RBs is 50 RBs. A single DCI scheduling multiple data messages may include scheduling information for at least one or more of the data messages in accordance with the first sub-BWP configuration and for at least one or more of the data messages in accordance with the second sub-BWP configuration. Such multiple data messages may include two or more downlink data messages sent via a physical downlink shared channel (PDSCH) or two or more uplink data messages sent via a physical uplink shared channel (PUSCH). In some aspects, the DCI message may include an explicit indication of which subband (of the multiple subbands within the active BWP) to use to communicate each data message of the multiple data messages. Such an explicit indication may include a bitmap, a field indicative of a codepoint, or a field indicative of a subband identifier (ID) and the UE may use the bitmap, the indicated codepoint, or the indicated subband ID to determine which subband to use to communicate each of the multiple data messages. Additionally, or alternatively, the DCI message may implicitly indicate which subband (of the multiple subbands within the active BWP) to use to communicate each data message of the multiple data messages. Such an implicit indication may be associated with the DCI message including multiple frequency domain resource allocation (FDRA) fields and a switching timeline, with the multiple FDRA fields and the switching timeline implicitly indicating, in conjunction, which subband to use to communicate each of the multiple data messages.

Further, some aspects relate to a subband switching time associated with the subbands within the active BWP, which may define a lower limit (such as a minimum) amount of time between two consecutive data messages that the UE communicates using two different subbands. For example, the subband switching time may define a lower limit amount of time for the UE to switch from a first subband associated with a relatively smaller quantity of PRBs to a second subband associated with a relatively greater quantity of PRBs. Additionally, or alternatively, the subband switching time (or a second subband switching time) may define a lower limit amount of time for the UE to switch from a first subband to a second subband that is non-overlapping (such as at least partially non-overlapping) with the first subband. In some aspects, the subband switching time may be associated with a capability of the UE and the UE may transmit an indication of the subband switching time to the network entity. In association with receiving an indication of the subband switching time, the network entity may schedule the multiple data messages in accordance with (such as in compliance with) the subband switching time.

Particular aspects of the subject matter of the present disclosure may be implemented to realize one or more of the following advantages. For example, by enabling a single DCI message to schedule multiple data messages in systems that support multiple subbands within an active BWP, various wireless communication devices (such as UEs and network entities) may achieve lower signaling overhead and higher data rates by way of using a single DCI message to schedule multiple data messages while also facilitating a “light” adaptation between the multiple subbands. By facilitating such “light” adaptation in more deployment scenarios (including, for example, deployment scenarios that use a single DCI message to schedule multiple data messages), the UE may experience lower device power consumption or greater performance, or both, by selectively using different subbands without adversely impacting other system protocols or functionalities. Further, by including an (explicit or implicit) indication of which subband to use to communicate each data message of the multiple data messages, the DCI message may resolve ambiguity regarding which subband(s) to use to communicate the multiple data messages, which may in turn increase a likelihood of successful communication. Moreover, by leveraging a subband switching time to define a lower limit amount of time between two data messages that use different subbands within the active BWP, the UE and the network entity may further increase the likelihood of successful communication by aligning expectations regarding a subband switching timeline at the UE and the network entity. In accordance with achieving lower signaling overhead, higher data rates, reduced ambiguity, or a greater likelihood of successful communication, the described techniques may further support greater spectral efficiency, greater user experience, or greater system capacity, among other benefits.

Aspects of the disclosure are initially described in the context of wireless communications systems. Additionally, aspects of the disclosure are illustrated by and described with reference to subband configurations, communication timelines, a signaling diagram, subband information designs, and a process flow. Aspects of the disclosure are further illustrated by and described with reference to apparatus diagrams, system diagrams, and flowcharts that relate to scheduling multiple data messages with light adaptation between subbands of an active BWP using a single DCI message.

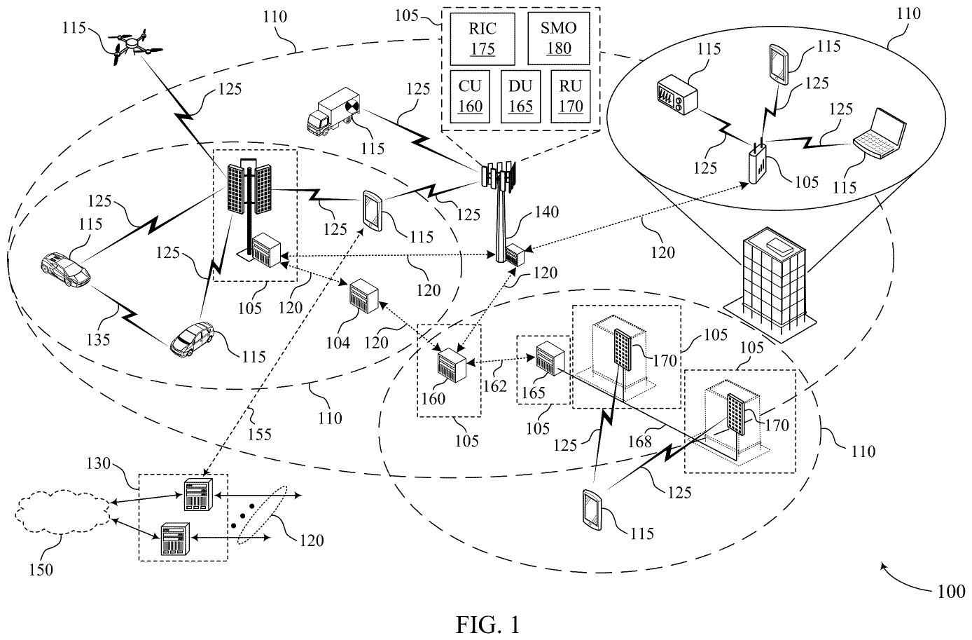

FIG. 1 shows an example of a wireless communications system 100 that supports scheduling multiple data messages with light adaptation between subbands of an active bandwidth part using a single downlink control information message. The wireless communications system 100 may include one or more devices, such as one or more network devices (such as network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (such as a radio frequency (RF) access link). For example, a network entity 105 may support a coverage area 110 (such as a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (such as other wireless communication devices, including UEs 115 or network entities 105), as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (such as in accordance with an S1, N2, N3, or other interface protocol). In some examples, network entities 105 may communicate with one another via backhaul communication link(s) 120 (such as in accordance with an X2, Xn, or other interface protocol) either directly (such as directly between network entities 105) or indirectly (such as via the core network 130). In some examples, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication link(s) 120, midhaul communication links 162, or fronthaul communication links 168 may be or include one or more wired links (such as an electrical link, an optical fiber link) or one or more wireless links (such as a radio link, a wireless optical link), among other examples or various combinations thereof. A UE 115 may communicate with the core network 130 via a communication link 155.

One or more of the network entities 105 or network equipment described herein may include or may be referred to as a base station 140 (such as a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (such as a base station 140) may be implemented in an aggregated (such as monolithic, standalone) base station architecture, which may be configured to utilize a protocol stack that is physically or logically integrated within one network entity (such as a network entity 105 or a single RAN node, such as a base station 140).

In some examples, a network entity 105 may be implemented in a disaggregated architecture (such as a disaggregated base station architecture, a disaggregated RAN architecture), which may be configured to utilize a protocol stack that is physically or logically distributed among multiple network entities (such as network entities 105), such as an integrated access and backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (such as a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some examples, one or more of the network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack, and the DU 165 may support one or more different layers of the protocol stack. In some examples, the CU 160 may host upper protocol layer (such as layer 3 (L3), layer 2 (L2)) functionality and signaling (such as Radio Resource Control (RRC), service data adaptation protocol (SDAP), Packet Data Convergence Protocol (PDCP)). The CU 160 (such as one or more CUs) may be connected to a DU 165 (such as one or more DUs) or an RU 170 (such as one or more RUs), or some combination thereof, and the DUs 165, RUs 170, or both may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack, and the RU 170 may support one or more different layers of the protocol stack. The DU 165 may support one or multiple different cells (such as via one or multiple different RUs, such as an RU 170). In some cases, a functional split between a CU 160 and a DU 165 or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (such as F1, F1-c, F1-u), and a DU 165 may be connected to an RU 170 via a fronthaul communication link 168 (such as open fronthaul (FH) interface). In some examples, a midhaul communication link 162 or a fronthaul communication link 168 may be implemented in accordance with an interface (such as a channel) between layers of a protocol stack supported by respective network entities (such as one or more of the network entities 105) that are in communication via such communication links.

In some wireless communications systems (such as the wireless communications system 100), infrastructure and spectral resources for radio access may support wireless backhaul link capabilities to supplement wired backhaul connections, providing an IAB network architecture (such as to a core network 130). In some cases, in an IAB network, one or more of the network entities 105 (such as network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (such as IAB donors) may be in communication with one or more additional devices (such as IAB node(s) 104) via supported access and backhaul links (such as backhaul communication link(s) 120). IAB node(s) 104 may include an IAB mobile termination (IAB-MT) controlled (such as scheduled) by one or more DUs (such as DUs 165) of a coupled IAB donor. An IAB-MT may be equipped with an independent set of antennas for relay of communications with UEs 115 or may share the same antennas (such as of an RU 170) of IAB node(s) 104 used for access via the DU 165 of the IAB node(s) 104 (such as referred to as virtual IAB-MT (vIAB-MT)). In some examples, the IAB node(s) 104 may include one or more DUs (such as DUs 165) that support communication links with additional entities (such as IAB node(s) 104, UEs 115) within the relay chain or configuration of the access network (such as downstream). In such cases, one or more components of the disaggregated RAN architecture (such as the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support scheduling multiple data messages with light adaptation between subbands of an active bandwidth part using a single downlink control information message as described herein. For example, some operations described as being performed by a UE 115 or a network entity 105 (such as a base station 140) may additionally, or alternatively, be performed by one or more components of the disaggregated RAN architecture (such as components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (such as one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (such as a bandwidth part (BWP)) that is operated according to one or more PHY layer channels for a given RAT (such as LTE, LTE-A, LTE-A Pro, NR). Each PHY layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a base station 140, a CU 160, a DU 165, a RU 170) of a RAN communicating with another device (such as directly or via one or more other network entities, such as one or more of the network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (such as 1.4, 3, 5, 10, 15, 20, 40, or 80 megahertz (MHz)). Devices of the wireless communications system 100 (such as the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (such as a subband, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which case the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively-numbered subframes or slots, and each subframe or slot may have the same duration. In some examples, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some examples, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to UEs 115 (such as one or more UEs) or may include UE-specific search space sets for sending control information to a UE 115 (such as a specific UE).

In some examples, a network entity 105 (such as a base station 140, an RU 170) may be movable and therefore provide communication coverage for a moving coverage area, such as the coverage area 110. In some examples, coverage areas 110 (such as different coverage areas) associated with different technologies may overlap, but the coverage areas 110 (such as different coverage areas) may be supported by the same network entity (such as a network entity 105). In some other examples, overlapping coverage areas, such as a coverage area 110, associated with different technologies may be supported by different network entities (such as the network entities 105). The wireless communications system 100 may include, for example, a heterogeneous network in which different types of the network entities 105 support communications for coverage areas 110 (such as different coverage areas) using the same or different RATs.

Some UEs 115 may be configured to employ operating modes that reduce power consumption, such as half-duplex communications (such as a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (such as according to narrowband communications), or a combination of these techniques. For example, some UEs 115 may be configured for operation using a narrowband protocol type that is associated with a defined portion or range (such as set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (such as one or more of the UEs 115) via a device-to-device (D2D) communication link, such as a D2D communication link 135 (such as in accordance with a peer-to-peer (P2P), D2D, or sidelink protocol). In some examples, one or more UEs 115 of a group that are performing D2D communications may be within the coverage area 110 of a network entity 105 (such as a base station 140, an RU 170), which may support aspects of such D2D communications being configured by (such as scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (such as less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A UE 115 may support multiple BWPs and may communicate with a network entity 105 via an active BWP of the multiple BWPs. Such multiple BWPs may include up to four uplink BWPs and up to four downlink BWPs, although UEs 115 described herein may support any quantity of uplink or downlink BWPs. For example, a UE 115 may support any quantity of BWPs for communication via one or more uplink channels and may support any quantity of BWPs for communication via one or more downlink channels. Uplink channels may include a physical uplink shared channel (PUSCH), a physical uplink control channel (PUCCH), or a physical random access channel (PRACH). A UE 115 and a network entity 105 may additionally, or alternatively, use an uplink BWP for sounding reference signal (SRS) transmissions, uplink configured grant (CG) transmissions, or at least some beam failure recovery (BFR) transmissions. Downlink channels may include a physical downlink shared channel (PDSCH) or a physical downlink control channel (PDCCH). A UE 115 and a network entity 105 may additionally, or alternatively, use a downlink BWP for downlink semi-persistent (SP) transmissions or at least some radio link management (RLM) transmissions.

Supporting and switching between different BWPs may enable a UE 115 to experience flexible spectrum assignment different from a carrier bandwidth. A UE 115 may support a single active BWP, such that the UE 115 may use one BWP as an active BWP at a time. Each of the multiple BWPs that a UE 115 supports may be associated with a respective set of configured parameters such that, in some cases, the UE 115 may use a first set of configured parameters in accordance with communicating via a first BWP and may use a second set of configured parameters in accordance with communicating via a second BWP.

For example, parameters associated with one or more of a bandwidth (such as 20 MHz or 100 MHz, among other examples), a subcarrier spacing (SCS), a modulation and coding scheme (MCS) table, a channel state information (CSI) configuration, a maximum rank, a control resource set (CORESET), an SRS configuration, a CG configuration, semi-persistently scheduled communications, beam failure reporting parameters, and RLM parameters may be configured on a per-BWP basis. Such parameters may be examples of RRC parameters, which may be organized in a BWP container (such that, in some aspects, BWPs may be understood as profiles). Use of BWPs may enable adaptation of radio (such as RRC) parameters at a UE 115. A BWP change may occur via RRC or DCI signaling or in accordance with an expiry of a BWP inactive timer. A change in a BWP may be associated with a change in a monitored or used bandwidth, such as a change from 20 MHz to 100 MHz for a time period within which a relatively large amount of data is to be transmitted to a UE 115.

Switching between BWPs may be associated with a corresponding switch between sets of configured parameters, which may involve a relatively “heavy” reconfiguration at a UE 115. For example, issues may arise in some deployment scenarios because of a relatively large quantity of configurations that are BWP-dependent. Such a “heavy” reconfiguration may be associated with a relatively high cost at the UE 115 to store the respective sets of configured parameters for each BWP or a relatively long timeline for the UE 115 to reconfigure parameters each time a BWP switch occurs. Thus, while supporting configurations on a per-BWP basis may provide relatively greater system flexibility, having a relatively large quantity of configurations that are BWP-dependent may incur some costs in terms of complexity at a UE 115.

For example, from a perspective of a UE 115, the UE 115 may either pay a relatively higher area cost to store a complete set of configurations (such as for a complete set of BWPs) or pay a timeline cost each time the UE 115 switches from one BWP to another BWP. A significant portion of a time delay associated with BWP switching may be spent reconfiguring the UE 115 with a set of parameters associated with the BWP to which the UE 115 is switching. Such reconfiguration may include both hardware and firmware reconfiguration. Further, with BWP-based operation, there may be a risk of a UE 115 being unreachable for a duration when the UE 115 moves to a wider BWP while a network entity 105 remains in a narrow BWP, or vice versa. A UE 115 may be unable to receive signaling (such as a DCI message) from a network entity 105 for the duration.

To mitigate such reconfiguration costs associated with BWP switches, some systems may support a light bandwidth adaptation mechanism according to which a network entity 105 may configure multiple subbands within a BWP, with the multiple subbands inheriting some of the parameters configured for the BWP and with each of the multiple subbands being configured with relatively smaller sets of unique parameters. For example, a UE 115 may receive first configuration information indicative of a set of parameters associated with a BWP and, as part of or within the first configuration information, second configuration information indicative of multiple subbands within the BWP. A unique parameter between the multiple subbands may include bandwidth such that, for example, a first subband may be associated with a first valid quantity of PRBs and a second subband may be associated with a second valid quantity of PRBs. A valid quantity of PRBs may correspond to or otherwise be understood as a quantity (such as a numeric value) of PRBs that is usable for scheduling communications between a UE 115 and a network entity 105. In accordance with such a “light” bandwidth adaptation mechanism, a set of (such as all) baseband configurations may remain the same across the multiple subbands within an active BWP, leading to an avoidance of a “heavy” reconfiguration at a UE 115 when the UE 115 switches between subbands. By supporting a “light” bandwidth adaptation mechanism, the UE 115 may support relatively more dynamic time, frequency, or antenna adaptation to save energy (such as battery power) at the UE 115.

In accordance with each of the multiple subbands being configured with relatively smaller sets of unique parameters and otherwise being associated with the same parameters as the BWP, switching between subbands may involve a relatively “light” adaptation at a UE 115. Such a “light” adaptation may be associated with a relatively short timeline at the UE 115 to reconfigure parameters each time a subband switch occurs. For example, in accordance with switching between subbands within an active BWP (such as adapting the bandwidth in accordance with the configuration of subbands and subband IDs within the active BWP), the UE 115 may reconfigure a relatively smaller quantity of parameters as compared to how many parameters the UE 115 may reconfigure in accordance with switching between BWPs, which may result in less down time per UE 115 and reduce penalties associated with a misalignment between the UE 115 and a network entity 105.

In some systems, a UE 115 and a network entity 105 may use a subband-based framework in addition to a BWP-based framework, with the UE 115 and the network entity 105 using the subband-based framework for “light” adaptation and using the BWP-based framework for a “full” adaptation (such as a full RRC reconfiguration). A UE 115 and a network entity 105 may support a range or spectrum of operations from “light” adaptation to “full” adaptation, which may be equivalently understood as a range or spectrum of operations from a DCI-based scheduling restriction to a full RRC reconfiguration. In between a DCI-based scheduling restriction and a full RRC reconfiguration, the UE 115 and the network entity 105 may support a DCI-based adaptation and a DCI-based full BWP switch, with a DCI-based scheduling restriction and a DCI-based adaptation being associated with relatively faster switching and with a DCI-based full BWP switch and a full RRC reconfiguration being associated with relatively more flexibility.

In some implementations, a UE 115 and a network entity 105 may support one or more mechanisms according to which the UE 115 and the network entity 105 are able to use a universal DCI design across various subbands within an active BWP (such as regardless of at which subband the UE 115 or the network entity 105 operates). In such implementations, the UE 115 and the network entity 105 may use or expect a size of one or more fields within a DCI message that is independent of the different valid quantities of PRBs of the multiple subbands within the active BWP. For example, a DCI message may include a field indicative of an FDRA (such as an FDRA field or a resource indication value (RIV) field) and, instead of a size of the field being dependent on a quantity of valid PRBs associated with a subband at which the network entity 105 operates, the size of the field may be the same across the multiple subbands within the active BWP. In other words, a DCI design (across one or multiple DCI formats) may remain according to a size and configuration of the active BWP). Additionally, the UE 115 and the network entity 105 may expect or provide a sufficient switching time to transition between different subbands.

In accordance with maintaining a same size for the field indicative of the FDRA across the multiple subbands within the active BWP, the UE 115 and the network entity 105 may support different interpretations of the field depending on at which subband the UE 115 and the network entity 105 operate. For example, the UE 115 and the network entity 105 may use a first interpretation of the field indicative of the FDRA in accordance with operating at the first subband (associated with the first valid quantity of PRBs) and may use a second interpretation of the field indicative of the FDRA in accordance with operating at the second subband (associated with the second valid quantity of PRBs). By supporting different interpretations depending on at which subband the UE 115 and the network entity 105 operate, the UE 115 and the network entity 105 may facilitate greater DCI decodability and lower device complexity, which may increase a reliability of communications and reduce device power consumption. In accordance with expecting or providing a sufficient switching time to transition between different subbands, the UE 115 and the network entity 105 may communicate in compliance with a capability of the UE 115, which may further increase the reliability of communications between the UE 115 and the network entity 105.

In some aspects, the UE 115 and the network entity 105 may support one or more signaling- or configuration-based mechanisms according to which the network entity 105 is able to use a single DCI message to schedule multiple data messages across potentially different subbands while maintaining both same DCI sizes across different subbands and providing a sufficient switching time to transition between different subbands. In some examples, the network entity 105 may generate or construct the single DCI message such that the single DCI message includes subband information that indicates (implicitly or explicitly) which subband the UE is to use to communicate each data message of the multiple data messages. Additionally, in some examples, the network entity 105 may generate or construct the single DCI message such that resource allocation information associated with the multiple data messages is in accordance with a subband switching time, with such a subband switching time defining a lower limit amount of time between two consecutive data messages (of the multiple data messages scheduled via the single DCI message) that use different subbands. As used herein, “consecutive data messages” may refer to a first data message and a next data message after the first data message, with the first data message and the next data message being immediately adjacent in time or being separated by a time gap (such as a time gap greater than or equal to a subband switching time). By providing a sufficient switching time to transition between different subbands, the UE 115 and the network entity 105 may experience a greater likelihood of successful communication, which may facilitate higher data rates and greater system capacity.

In some implementations, the UE 115 and the network entity 105 may support multiple subbands within an active BWP in addition to, or as an alternative from, supporting other functionalities, such as subband full-duplex. Subband full-duplex may be associated with some slots in which downlink communication is associated with a wideband (such as a full bandwidth) and some other slots in which downlink communication shares a bandwidth with uplink communication. For subband full-duplex, a single DCI message may schedule multiple downlink data messages with the multiple downlink data messages sometimes falling (such as being located) in subband full-duplex slots (such as slots in which downlink communication shares a bandwidth with uplink communication) and sometimes falling in non-subband full-duplex slots (such as slots in which downlink communication occupies a full bandwidth). In subband full-duplex, however, a scheduling DCI message excludes information indicative of which subband to use for each of multiple data messages. Instead, the scheduled data messages follow a subband full-duplex slot pattern that is configured by other signaling (such as RRC signaling). For example, in subband full-duplex, a scheduling DCI message excludes a subband ID field (such as a field indicative of a subband ID index). Further, in subband full-duplex operation, the UE 115 does not adjust (such as retune) an RF bandwidth or associated baseband configurations when moving between subband full-duplex slots and non-subband full-duplex slots. Instead, the UE 115 operates at a same overall RF bandwidth across both subband full-duplex slots and non-subband full-duplex slots (and instead adjusts which frequency domain resources are used for downlink and which frequency domain resources (if any) are used for uplink depending on whether a slot is a subband full-duplex slot or a non-subband full-duplex slot).

Thus, in accordance with implementing the described techniques, including by providing subband information indicative of which subband to use for each of multiple data messages within a single scheduling DCI message, the UE 115 may retune an RF bandwidth or associated baseband configurations when switching between subbands within an active BWP across the multiple scheduled data messages, which may enable the UE 115 to more suitably (including with lower latency) adapt a power consumption at the UE 115 over time, which may in turn facilitate longer battery life at the UE 115. Accordingly, the described techniques may provide for longer battery life at the UE 115, among other benefits described herein, beyond that which subband full-duplex operation may provide to the UE 115.

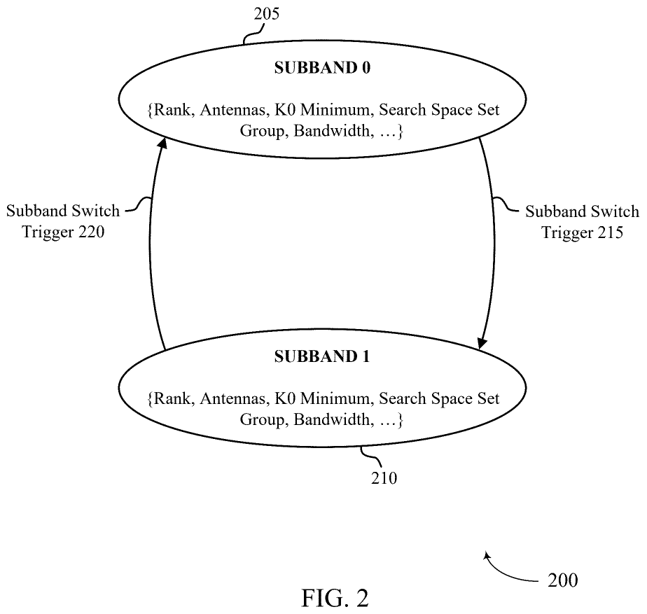

FIG. 2 shows an example of a subband configuration 200, of multiple subbands within an active BWP, that supports scheduling multiple data messages with light adaptation between subbands of an active BWP using a single DCI message. The subband configuration 200 may implement or be implemented to realize or facilitate one or more aspects of the wireless communications system 100. For example, the subband configuration 200 may define a first subband 205 (illustrated in the example of FIG. 2 as a “subband 0”) and a second subband 210 (illustrated in the example of FIG. 2 as a “subband 1”) within a BWP. For example, a UE 115 and a network entity 105, such as a UE 115 and a network entity 105 as illustrated by and described with reference to FIG. 1, may support the subband configuration 200 to realize or facilitate one or more aspects of the present disclosure.

The first subband 205 and the second subband 210 may be associated with a set of parameters that is also associated with the BWP that includes the first subband 205 and the second subband 210. Additionally, in some examples, the first subband 205 and the second subband 210 may be associated with unique (and smaller) sets of parameters that are subband-specific. Such smaller sets of parameters that are subband-specific may include one or more of a (maximum) rank, a quantity of operated antennas (such as a quantity of active receive (Rx) or transmit (Tx) antennas), timeline parameters (such as a K0 or K2 minimum, which may be understood as a minimum scheduling offset), a search space set group (such as a search space periodicity, such as to replace search space set group switching without a possibility of changing CORESET), and a bandwidth, among other examples. For example, the first subband 205 may be associated with one or more of a first (maximum) rank, a first quantity of operated antennas, a first K0 or K2 minimum, a first search space set group, and a first bandwidth (such as a first valid quantity of PRBs). By way of further example, the second subband 210 may be associated with one or more of a second (maximum) rank, a second quantity of operated antennas, a second K0 or K2 minimum, a second search space set group, and a second bandwidth (such as a second valid quantity of PRBs).

The first subband 205 may be equivalently referred to herein as a first bandwidth of the BWP, a first sub-BWP of the BWP, a first resource block (RB) set of the BWP, a first valid quantity of RBs of the BWP, a first one or more RBGs of the BWP, or a first power state of the BWP. The second subband 210 may be equivalently referred to herein as a second bandwidth of the BWP, a second sub-BWP of the BWP, a second RB set of the BWP, a second valid quantity of RBs of the BWP, a second one or more RBGs of the BWP, or a second power state of the BWP.

In some aspects, the first subband 205 may be associated with a first communication configuration (such as a first state or mode) and the second subband 210 may be associated with a second communication configuration (such as a second state or mode). The first communication configuration may be associated with, indicate, define, or specify a first maximum bandwidth, a first minimum processing timeline, a first minimum scheduling offset, or a first maximum rank. The second communication configuration may be associated with, indicate, define, or specify a second maximum bandwidth, a second minimum processing timeline, a second minimum scheduling offset, or a second maximum rank. In examples in which the first subband 205 includes a relatively smaller valid quantity of PRBs as compared to the second subband 210, the first maximum bandwidth may be smaller than the second maximum bandwidth, the first minimum processing timeline may be longer than the second minimum processing timeline, the first minimum scheduling offset may be longer than the second minimum scheduling offset, or the first maximum rank may be relatively smaller than the second maximum rank. In such examples, the first subband 205 may be associated with a low power state and the second subband 210 may be associated with a high power state. In some implementations, the UE 115 may switch between operation in accordance with the first communication configuration and the second communication configuration more quickly than switching between BWPs (because of the fewer unique parameters between two subbands as compared to between two BWPs). Such faster switching may enable the UE 115 to more dynamically move between low and high power states, which may facilitate more efficient power consumption at the UE 115 and longer battery life, among other benefits.

The UE 115 and the network entity 105 may support a subband switch trigger 215 to switch from the first subband 205 to the second subband 210 and may support a subband switch trigger 220 to switch from the second subband 210 to the first subband 205. Such switching triggers may be one or more of DCI-based, timer-based, or event-based, among other examples. In some aspects, subband switching may be accompanied with, triggered by, or indicated by a scheduling delay, such as K0/K2 being greater than 0. Same slot scheduling may be possible according to active adaptation parameters (such as adaptation between subband-specific parameters). In some aspects, a DCI may remain unchanged (such as in terms of size or format) through adaptation. The DCI remaining unchanged may increase the likelihood of the UE 115 being able to decode the DCI (even in scenarios in misalignment between the UE 115 and the network entity 105) and may reduce an amount of reprogramming at the UE 115.

In some implementations, the UE 115 may receive a DCI message that schedules multiple data messages across multiple subbands, such as across the first subband 205 and the second subband 210. In other words, a single DCI may schedule multiple data messages in different subbands (such as in different power states, such as in a “high power state” subband and in a “low power state” subband), with the different subbands differing by RF bandwidth and sharing one or more other configuration parameters. In some examples, the different subbands may differ by RF bandwidth only and every other configuration parameter (such as DCI size or FDRA field size) may remain the same across the different subbands.

In some examples, the DCI message may include resource allocation information (such as scheduling information) associated with multiple data messages and may include subband information indicative of which subband (of the first subband 205 or the second subband 210) the UE 115 is to use to communicate each data message of the multiple data messages. In some examples, the multiple data messages may include a first set of one or more data messages indicated (by or via the subband information) to be communicated using the first subband 205 and may include a second set of one or more data messages indicated (by or via the subband information) to be communicated using the second subband 210. In such examples, the UE 115 may operate in accordance with the first communication configuration when communicating the first set of one or more data messages and may operate in accordance with the second communication configuration when communicating the second set of one or more data messages.

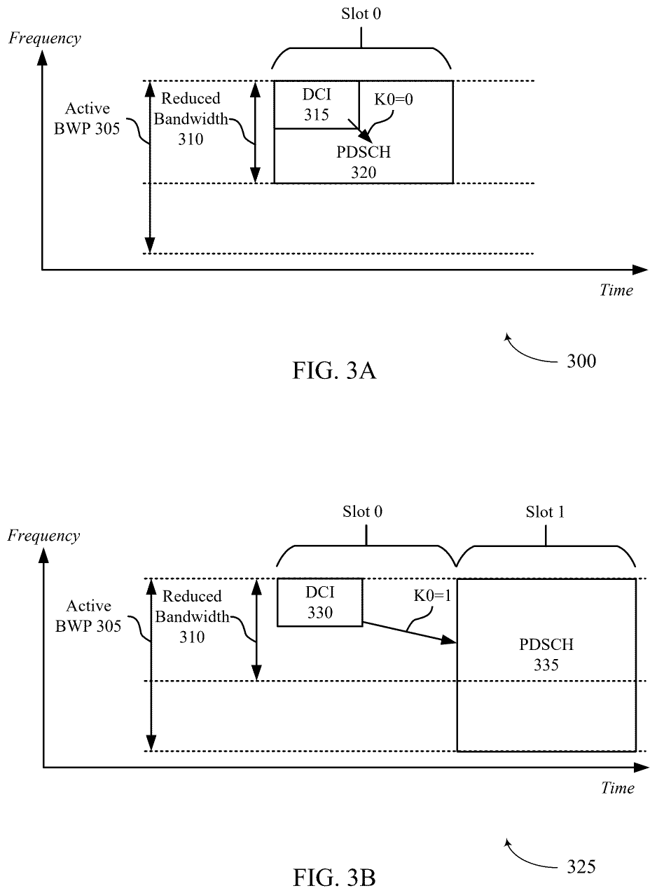

FIGS. 3A and 3B show examples of a communication timeline 300 and a communication timeline 325, respectively, in which a DCI message schedules a data message in accordance with light adaptation between subbands of an active BWP. The communication timeline 300 and the communication timeline 325 may implement or be implemented to realize or facilitate one or more aspects of the wireless communications system 100 or the subband configuration 200. For example, a UE 115 and a network entity 105, which may be examples of corresponding devices described herein, may communicate in accordance with the communication timeline 300 or the communication timeline 325.

For example, the UE 115 and the network entity 105 may communicate via an active BWP 305. In some implementations, the UE 115 and the network entity 105 may support multiple subbands within the active BWP 305. In such implementations, a first subband (such as the first subband 205) may be associated with a first bandwidth (such as a first valid quantity of PRBs) and a second subband (such as the second subband 210) may be associated with a second bandwidth (such as a second valid quantity of PRBs). In some examples, the first bandwidth may be a reduced bandwidth 310 and the second bandwidth may be a full bandwidth of the active BWP 305. In such examples, the first subband may be a subset of the second subband. In other words, the first valid quantity of PRBs may be a subset of the second valid quantity of PRBs. The full bandwidth of the active BWP 305 may be understood or referred to as a carrier bandwidth.

In accordance with the communication timeline 300, the UE 115 may receive, from the network entity 105, a DCI message 315 that includes scheduling information associated with a data message (such as a downlink data message) to be communicated via a PDSCH 320. The DCI message 315 may indicate a slot offset (such as a scheduling offset) of K0=0, which may schedule the data message (such as the PDSCH 320) for a same slot within which the UE 115 receives the DCI message 315. In accordance with the example of the communication timeline 300, the UE 115 and the network entity 105 may operate at the first subband (such as the reduced bandwidth 310).

The first subband (such as the reduced bandwidth 310) may be associated with a scheduling restriction. For example, the UE 115 or the network entity 105 may use a scheduling restriction to adapt operation (such as to adapt bandwidth). By way of further example, a scheduled PDSCH or PUSCH that exceeds the reduced bandwidth 310 may be considered as an invalid grant in accordance with the UE 115 or the network entity 105 operating at the first subband. In some aspects, such a scheduling restriction may be timing-based such that, for example, the UE 115 or the network entity 105 may not expect the DCI message 315 to schedule a data message with an FDRA that exceeds the reduced bandwidth 310 within a threshold duration (such as a threshold K0 value, which may be a K0 value of 0) of the DCI message 315. If the data message is scheduled past the threshold duration (such as with a K0 value of 1 or greater), the UE 115 or the network entity 105 may allow the DCI message 315 to schedule a data message with an FDRA that exceeds the reduced bandwidth 310.

In accordance with the communication timeline 325, the UE 115 may receive, from the network entity 105, a DCI message 330 that includes scheduling information associated with a data message (such as a downlink data message) to be communicated via a PDSCH 335. The DCI message 330 may indicate a slot offset (such as a scheduling offset) of K0=1, which may schedule the data message (such as the PDSCH 335) for a next slot after the slot within which the UE 115 receives the DCI message 330. In accordance with the example of the communication timeline 325, the UE 115 and the network entity 105 may operate at the second subband (such as the full bandwidth of the active BWP 305), at least for communication (such as transmission or reception) of the data message.

In accordance with the communication timeline 300 or the communication timeline 325, the UE 115 may experience dynamic subband switching and may communicate different data messages using different subbands, which may enable the UE 115 to selectively use fewer or greater quantities of communication resources (such as time or frequency resources) for different data messages. The UE 115 may use greater quantities of communication resources for data messages associated with a greater amount of data and may use fewer quantities of communication resources for data messages associated with a lesser amount of data. In accordance with such operation, the UE 115 and the network entity 105 may make more efficient use of available system resources and more suitably use power resources at the UE 115, which may achieve a target balance between performance and battery life at the UE 115.

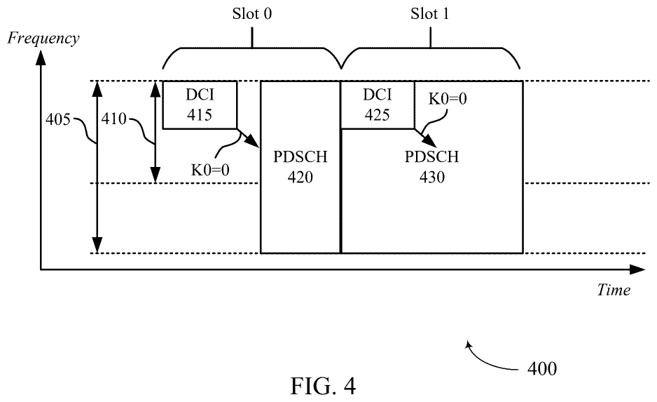

FIG. 4 shows an example of a communication timeline 400 in which a DCI message schedules a data message in accordance with light adaptation between subbands of an active BWP. The communication timeline 400 may implement or be implemented to realize or facilitate one or more aspects of the wireless communications system 100, the subband configuration 200, the communication timeline 300, or the communication timeline 325. For example, a UE 115 and a network entity 105, which may be examples of corresponding devices described herein, may communicate in accordance with the communication timeline 400.

For example, the UE 115 and the network entity 105 may communicate via an active BWP 405. In some implementations, the UE 115 and the network entity 105 may support multiple subbands within the active BWP 405. In such implementations, a first subband (such as the first subband 205) may be associated with a first bandwidth (such as a first valid quantity of PRBs) and a second subband (such as the second subband 210) may be associated with a second bandwidth (such as a second valid quantity of PRBs). In some examples, the first bandwidth may be a reduced bandwidth 410 and the second bandwidth may be a full bandwidth of the active BWP 405. In such examples, the first subband may be a subset of the second subband. In other words, the first valid quantity of PRBs may be a subset of the second valid quantity of PRBs. The full bandwidth of the active BWP 405 may be understood or referred to as a carrier bandwidth.

In accordance with the communication timeline 400, the UE 115 may receive, from the network entity 105, a DCI message 415 that includes scheduling information associated with a data message (such as a downlink data message) to be communicated via a PDSCH 420. The DCI message 415 may indicate a slot offset (such as a scheduling offset) of K0=0, which may schedule the data message (such as the PDSCH 420) for a same slot within which the UE 115 receives the DCI message 415. Alternatively, the network entity 105, via the DCI message 415, may provide a sufficient retune time between the DCI message 415 and the PDSCH 420 to enable the UE 115 to retune one or more RF parameters or components (such as one or more antennas) or baseband configurations (such as to enable the UE 115 to switch from using the reduced bandwidth 410 to the full bandwidth of the active BWP 405). In other words, to schedule the PDSCH 420 in the full bandwidth of the active BWP 405 (which may be understood as a high power state), the network entity 105 may provide an RF retune time for the UE 115. In such examples, K0 may be a value greater than 0 (such as 1 or 2, among other examples).

Additionally, the UE 115 may receive, from the network entity 105, a DCI message 425 that includes scheduling information associated with a data message (such as a downlink data message) to be communicated via a PDSCH 430. The DCI message 425 may indicate a slot offset (such as a scheduling offset) of K0=0, which may schedule the data message (such as the PDSCH 430) for a same slot within which the UE 115 receives the DCI message 425. In accordance with the example of the communication timeline 400, the UE 115 and the network entity 105 may operate at the second subband (such as the full bandwidth of the active BWP 405).

In accordance with the communication timeline 400, the UE 115 may experience dynamic subband switching and may communicate different data messages using different subbands, which may enable the UE 115 to selectively use fewer or greater quantities of communication resources (such as time or frequency resources) for different data messages. The UE 115 may use greater quantities of communication resources for data messages associated with a greater amount of data and may use fewer quantities of communication resources for data messages associated with a lesser amount of data. In accordance with such operation, the UE 115 and the network entity 105 may make more efficient use of available system resources and more suitably use power resources at the UE 115, which may achieve a target balance between performance and battery life at the UE 115.

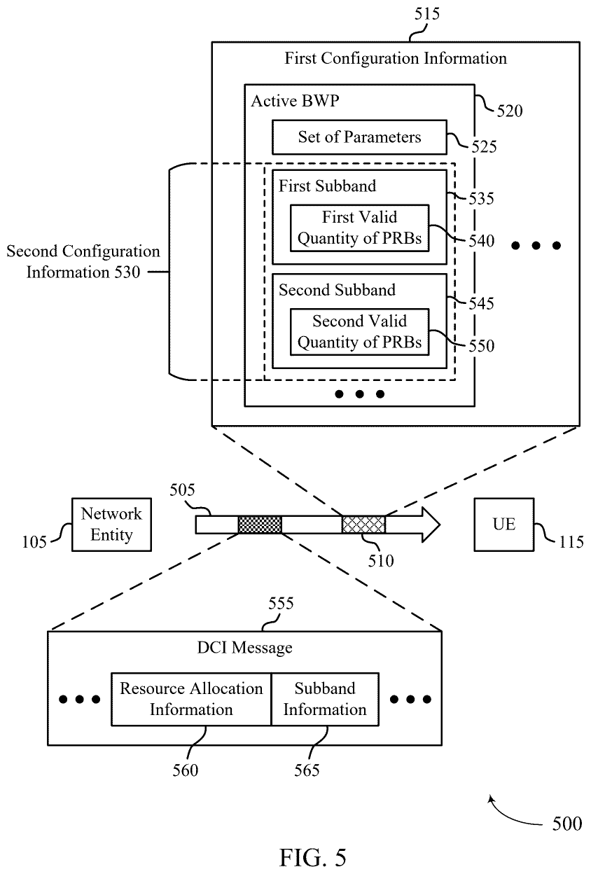

FIG. 5 shows an example of a signaling diagram 500 between a UE 115 and a network entity 105 that supports scheduling multiple data messages with light adaptation between subbands of an active BWP using a single DCI message. The signaling diagram 500 may implement or be implemented to realize or facilitate one or more aspects of the wireless communications system 100, the subband configuration 200, the communication timeline 300, the communication timeline 325, or the communication timeline 400. The UE 115 and the network entity 105, which may be examples of corresponding devices described herein, may communicate via a communication link 505 (such as a downlink).

The UE 115 may receive control signaling 510 from the network entity 105 indicative of configuration information. Such control signaling 510 may include RRC signaling, one or more MAC control elements (MAC-CEs), one or more DCI messages, or any combination thereof. The control signaling 510 may configure the UE 115 with one or more parameters associated with one or more BWPs and one or more subbands within each BWP. For example, the control signaling 510 may indicate first configuration information 515 indicative of a set of parameters 525 associated with an active BWP 520 (such as a configured BWP that is used as an active BWP) and, as part of the first configuration information 515, second configuration information 530 indicative of a first subband 535 and a second subband 545 within the active BWP 520. The control signaling 510 may indicate, configure, or define one or more other BWPs in addition to the active BWP 520 (including one or both of uplink BWPs and downlink BWPs) and may indicate, configure, or define whether a BWP includes one or multiple subbands on a per-BWP basis.

The set of parameters 525 may include any one or more parameters that are configured as being associated with the active BWP 520 and, in some aspects, may be inherited by or common to (such as universally applicable to) the first subband 535 and the second subband 545. For example, the set of parameters 525 may include one or more parameters associated with a BWP bandwidth (such as 20 MHz or 100 MHz, among other examples), one or more parameters associated with an SCS, one or more parameters associated with an MCS table, one or more parameters associated with a CSI configuration, one or more parameters associated with a maximum rank, one or more parameters associated with a CORESET, one or more parameters associated with an SRS configuration, one or more parameters associated with a CG configuration, one or more parameters associated with semi-persistently scheduled communications, one or more parameters associated with beam failure reporting, one or more parameters associated with RLM, or any combination thereof, among other examples of BWP-specific parameters.

In some aspects, the set of parameters 525 may include one or more baseband parameters, such that configurations to baseband remain the same (or at least partially the same) between subbands of the active BWP 520. Such baseband parameters (that remain the same between subbands of the active BWP 520) may include CORESET and DCI size configurations. For example, a DCI size may remain the same according to a size and configuration of a widest subband of the active BWP 520. In accordance with maintaining same baseband configurations across the subbands within the active BWP 520, the UE 115 may be reachable (by way of a decodable DCI) regardless of at which subband the UE 115 operates (even in scenarios in which there is a subband mismatch between the UE 115 and the network entity 105). For example, even in scenarios in which the UE 115 and the network entity 105 are out of synchronization, the UE 115 may be able to decode the DCI and determine whether the UE 115 is out of synchronization with the network entity 105 (and, if so, the UE 115 may indicate the out of synchronization state to the network entity 105).

The second configuration information 530 may indicate (such as define or configure) subbands within the active BWP 520 and provide (such as assign) a subband ID to each subband within the active BWP 520. For example, the second configuration information 530 may indicate an ID of “0” for the first subband 535 and may indicate an ID of “1” for the second subband 545. Subsequent signaling (such as one or more DCI messages) between the UE 115 and the network entity 105 may refer to the first subband 535 or the second subband 545 by subband ID. For example, a DCI message may include a field indicative of a subband ID (which may indicate via which subband a scheduled data message is to be transmitted), which may increase a size of the DCI message as compared to DCI messages in systems unsupportive of multiple subbands within an active BWP.

The second configuration information 530 may indicate that the first subband 535 includes or is otherwise associated with a first valid quantity of PRBs 540 and that the second subband 545 includes or is otherwise associated with a second valid quantity of PRBs 550, among one or more other subband-specific parameters. Additionally, or alternatively, the second configuration information 530 may indicate that the first subband 535 includes or is otherwise associated with a first RB set, a first valid quantity of RBs, or a first valid quantity of RBGs and that the second subband 545 includes or is otherwise associated with a second RB set, a second valid quantity of RBs, or a second valid quantity of RBGs.

In some examples, the first subband 535 (which may be an example of the first subband 205) may be associated with a relatively restricted or narrow bandwidth and the second subband 545 (which may be an example of the second subband 210) may be associated with a relatively wide bandwidth. In such examples in which the first subband 535 is relatively narrower as compared to the second subband 545, the second valid quantity of PRBs 550 may be greater than the first valid quantity of PRBs 540. In some implementations, the first valid quantity of PRBs 540 may be a subset of the second valid quantity of PRBs 550 (such that the first subband 535 may likewise be a subset of the second subband 545). In some other implementations, the first valid quantity of PRBs 540 and the second valid quantity of PRBs 550 may be partially or completely non-overlapping (such that the first subband 535 may likewise be at least partially non-overlapping with the second subband 545).

In some implementations, the UE 115 and the network entity 105 may support one or more signaling- or configuration-based mechanisms according to which the UE 115 and the network entity 105 may support a single DCI message that schedules multiple data messages within the active BWP 520 that includes the first subband 535 and the second subband 545. In such implementations, the single DCI message may include information indicative of which subband to use to communicate each data message of the multiple data messages. Additionally, or alternatively, the single DCI message may include information indicative of which subband to use to communicate at least one data message of the multiple data messages. The UE 115 may use such information to determine (such as to select, identify, or otherwise ascertain) which subband to use to communicate at least one (such as each) data message of the multiple data messages.

For example, the UE 115 may receive, from the network entity 105, a DCI message 555 that includes resource allocation information 560 (such as scheduling information) associated with multiple data messages. Such resource allocation information 560 may include one or more time domain resource allocations (TDRAs) (such as one or more slot or symbol offsets), one or more FDRAs, one or more subband IDs, or one or more redundancy versions, among other examples. For example, the DCI message 555 may be a scheduling DCI that schedules the multiple data messages.

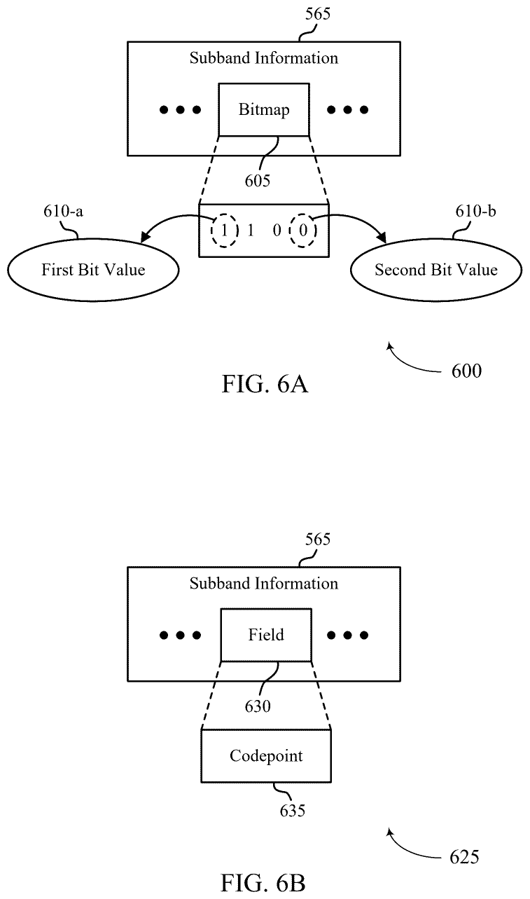

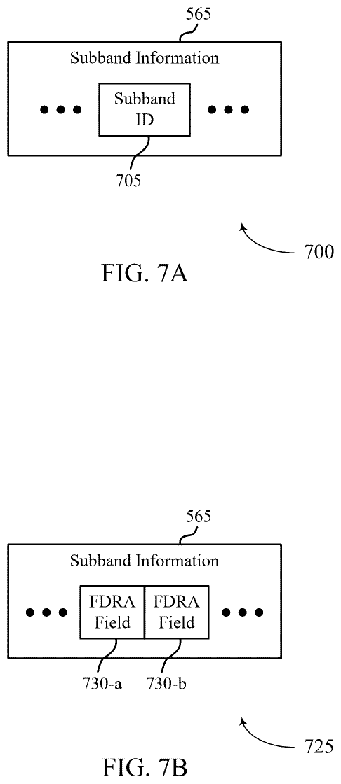

In addition to the resource allocation information 560, the DCI message 555 may include subband information 565 indicative of which subband (of the first subband 535 and the second subband 545, potentially among other subbands within the active BWP) the UE 115 is to use to communicate at least one (such as each) data message of the multiple data messages. The DCI message 555 may provide, convey, or indicate the resource allocation information 560 via a first set of one or more fields and may provide, convey, or indicate the subband information 565 via a second set of one or more fields. The first set of one or more fields may be the same as, partially the same as, or completely different from the second set of one or more fields. Additional details related to the subband information 565 are illustrated and described herein, including by and with reference to FIGS. 6A, 6B, 7A, and 7B. In accordance with communicating both the resource allocation information 560 and the subband information 565 via the DCI message 555, the UE 115 and the network entity 105 may efficiently (such as with relatively low signaling overhead) obtain a mutual understanding regarding which subband is to be used to communicate each scheduled data message.

The DCI message 555 may be associated with a DCI format 1_1 or a DCI format 0_1. Some example fields within the DCI message 555 include an FDRA field, an MCS field (for a first or a second transport block (TB)), an antenna ports field, a priority field, a virtual resource block (VRB)-to-PRB mapping field, a PRB bundling size field, a zero power (ZP) CSI reference signal (ZP-CSI-RS) trigger field, a rate matching indicator field, a downlink assignment indicator (DAI) field, a TDRA field, a new data indicator (NDI) field (for a first or a second TB), a redundancy version ID (RVID) field (for a first or a second TB), a hybrid automatic repeat request (HARQ) ID field, a code block group transmission indicator (CBGTI) or code block group flush information (CBGFI) (CBGTI/CBGFI) field, or any combination thereof. In some examples, the FDRA, MCS, and antenna ports fields may apply to all scheduled data messages. In some examples, a triggered ZP-CSI-RS may apply to all slots with a scheduled data message. In some examples, the DAI field may be associated with an interpretation that is associated with the DCI message 555 scheduling multiple data messages. In some examples, the TDRA field may indicate an entry or row within a TDRA table that supports multiple start and length indicator values (SLIVs), such as up to eight SLIVs. Discontinuous SLIVs may be supported.

The NDI field may provide one bit per TB (and may be validation dependent). The RVID field may provide one bit per TB if multiple TBs are scheduled (and may be validation dependent and may indicate between RVID 0 and 2). The RVID field may include two bits if a single data message is scheduled. The HARQ ID field may apply to a first (such as initial) scheduled data message and each additional scheduled data message may have an incremented HARQ ID. The CBGTI/CBGFI field may be supported for 120 kilohertz (kHz) (such as a 120 kHz SCS) and may selectively be included when a single data message is scheduled (and may share bits with unused bits from one or both of the NDI or RVID fields).

FIGS. 6A and 6B show examples of a subband information design 600 and a subband information design 625, respectively, that support scheduling multiple data messages with light adaptation between subbands of an active BWP using a single DCI message. The subband information design 600 and the subband information design 625 may implement or be implemented to realize one or more aspects of the wireless communications system 100, the subband configuration 200, the communication timeline 300, the communication timeline 325, the communication timeline 400, or the signaling diagram 500. For example, a UE 115 may receive, from a network entity 105, a DCI message (such as a DCI message 555, as illustrated by and described with reference to FIG. 5) that includes subband information 565 in accordance with the subband information design 600 or the subband information design 625, the subband information 565 indicative of which subband the UE 115 is to use to communicate each of multiple data messages scheduled by the DCI message.

In accordance with the subband information design 600, the subband information 565 may include or be indicated by a bitmap 605 that indicates which subband the UE 115 is to use to communicate each data message of the multiple data messages. In other words, the DCI message may include an explicit indication of which data messages out of the multiple data messages are to be communicated using the first subband 535 (such as in a low power state) and which data messages out of the multiple data messages are to be communicated using the second subband 545 (such as in a high power state) via a bitmap 605. In some aspects, each bit of the bitmap 605 corresponds to a respective data message of the multiple data messages and indicates which subband the UE 115 is to use to communicate the respective data message. In such aspects, the bitmap 605 may include N bits in accordance with the DCI message including scheduling information associated with N data messages. Using the subband information design 600, the UE 115 and the network entity 105 may efficiently communicate the subband information 565 via a DCI message and unambiguously determine which subband to use for each data message scheduled by the DCI message.

For example, a first bit value 610-a (such as a bit value of “1”) indicates the UE 115 to use the first subband 535 to communicate a corresponding data message and a second bit value 610-b (such as a bit value of “0”) indicates the UE 115 to use the second subband 545 to communicate the corresponding data message. By way of example, a bitmap 605 of “1 1 0 0” may indicate that the UE 115 is to use the first subband 535 to communicate a first data message and a second data message and that the UE 115 is to use the second subband 545 to communicate a third data message and a fourth data message. By way of further example, a bitmap 605 of “1 0 1 0” may indicate that the UE 115 is to use the first subband 535 to communicate a first data message and a third data message and that the UE 115 is to use the second subband 545 to communicate a second data message and a fourth data message.

In accordance with the subband information design 625, the subband information 565 may include or be indicated by a field 630 indicative of a codepoint 635 that indicates which subband the UE 115 is to use to communicate each data message of the multiple data messages. In other words, the DCI message may include an explicit indication of which data messages out of the multiple data messages are to be communicated using the first subband 535 (such as in a low power state) and which data messages out of the multiple data messages are to be communicated using the second subband 545 (such as in a high power state) via a codepoint 635. In some aspects, different codepoints of the field 630 may indicate different subband patterns the UE 115 is to use to communicate the multiple data messages. A subband pattern may define, indicate, or correspond to a permutation associated with using the first subband 535 or the second subband 545, or both, to communicate the multiple data messages. Different subband patterns may define, indicate, or correspond to different permutations regarding which data messages (if any) to communicate using the first subband 535 and which data messages (if any) to communicate using the second subband 545. Using the subband information design 625, the UE 115 and the network entity 105 may efficiently communicate the subband information 565 via a DCI message and unambiguously determine which subband to use for each data message scheduled by the DCI message.

For example, a first codepoint 635 of the field 630 may indicate the UE 115 to communicate the multiple data messages in accordance with a first pattern of subbands, a second codepoint 635 of the field 630 may indicate the UE 115 to communicate the multiple data messages in accordance with a second pattern of subbands, and so on. By way of further example, a first codepoint 635 of the field 630 may indicate the UE 115 to use the first subband 535 to communicate the (such as all of the) multiple data messages, a second codepoint 635 of the field 630 may indicate the UE 115 to use the first subband 535 to communicate a first one or more of the multiple data messages and to use the second subband 545 to communicate a second one or more of the multiple data messages, and a third codepoint 635 of the field 630 may indicate the UE 115 to use the second subband 545 to communicate the (such as all of the) multiple data messages.

In some examples, to limit how many subband switches the UE 115 is scheduled to perform, the UE 115 and the network entity 105 may employ or use a scheduling expectation (such as a scheduling constraint or restriction) that there may be at most a single subband switch (such as a single subband transition) across the multiple data messages. In such examples, the UE 115 may not expect to switch back and forth between two or more subbands multiple times across the multiple data messages scheduled by the single DCI message. In at least some of such examples, among other examples, the field 630 may include log₂ (2N) bits (such as 1+log (N) bits) in accordance with the DCI message including scheduling information associated with N data messages. Using log₂ (2N) bits to communicate the subband information 565 may result in lower signaling overhead (as, for example, log₂ (2N)<N).

For example, log₂ (2N) bits may be sufficient to convey any one of the codepoints as illustrated in Table 1, shown below, each of which may indicate a respective subband pattern associated with N data messages. In other words, log₂ (2N) bits may be sufficient to convey 2N possibilities (such as 2N different subband patterns). The UE 115 may receive information indicative of the different possible subband patterns via signaling, such as via RRC signaling, one or more MAC-CEs, or one or more DCI messages. Additionally, or alternatively, the UE 115 may retrieve one or more of the different possible subband patterns from one or more memories associated with (such as within or otherwise accessible by) the UE 115.

TABLE 1
Correspondence Between a Codepoint 635 and Subband Pattern
the UE 115 is to Use to Communicate Multiple Data Messages

| Codepoint 635 of | |
|---|---|
| the Field 630 | Subband Pattern |
| First Codepoint | All N data messages to be communicated using the |
| | first subband 535 |
| Second Codepoint | Initial data message to be communicated using the first |
| | subband 535; remaining N − 1 data messages to be |
| | communicated using the second subband 545 |
| Third Codepoint | Initial N − 1 data messages to be communicated using |
| | the first subband 535; final data message to be |
| | communicated using the second subband 545 |
| Fourth Codepoint | All N data messages to be communicated using the |
| | second subband 545 |
| Fifth Codepoint | Initial data message to be communicated using the |
| | second subband 545; remaining N − 1 data messages |
| | to be communicated using the first subband 535 |
| Sixth Codepoint | Initial N − 1 data messages to be communicated using |
| | the second subband 545; final data message to be |
| | communicated using the first subband 535 |
| . . . | . . . |

The field 630 may indicate one or more other codepoints in addition to, or as alternatives from, the codepoints illustrated in Table 1. For example, another codepoint 635 of the field 630 may indicate that an initial N−X data messages are to be communicated using the first subband 535 and that a final X data messages are to be communicated using the second subband 545. By way of further example, yet another codepoint 635 of the field 630 may indicate that an initial N−X data messages are to be communicated using the second subband 545 and that a final X data messages are to be communicated using the first subband 535. In such examples, X may be any integer including, for example, 2, 3, 4, 5, 6, or 7.

In some implementations, the UE 115 and the network entity 105 may more generally employ or use a scheduling expectation (such as a scheduling constraint or restriction) that there may be at most a threshold quantity of subband switches (such as a threshold quantity of subband transitions) across the multiple data messages. Such a threshold quantity may be 0, 1, 2, or 3, among other examples. A mapping (such as a correspondence) between codepoints and subband patterns (or a quantity of the possible codepoints, or both) may be associated with the threshold quantity of subband switches. The UE 115 may receive information indicative of the threshold quantity of subband switches via signaling, such as via RRC signaling, one or more MAC-CEs, or one or more DCI messages. Additionally, or alternatively, the UE 115 may retrieve the threshold quantity of subband switches from one or more memories associated with (such as within or otherwise accessible by) the UE 115. Additionally, or alternatively, the UE 115 may transmit information indicative of the threshold quantity of subband switches via signaling, such as via UE assistance signaling (such as capability signaling), one or more MAC-CEs, or one or more uplink control information (UCI) messages.

FIGS. 7A and 7B show examples of a subband information design 700 and a subband information design 725, respectively, that support scheduling multiple data messages with light adaptation between subbands of an active BWP using a single DCI message. The subband information design 700 and the subband information design 725 may implement or be implemented to realize one or more aspects of the wireless communications system 100, the subband configuration 200, the communication timeline 300, the communication timeline 325, the communication timeline 400, or the signaling diagram 500. For example, a UE 115 may receive, from a network entity 105, a DCI message (such as a DCI message 555, as illustrated by and described with reference to FIG. 5) that includes subband information 565 in accordance with the subband information design 700 or the subband information design 725.

In accordance with the subband information design 700, the subband information 565 may include or be indicated by a subband ID 705 (such as a field indicative of a subband ID 705). In such aspects in which the subband information 565 includes or is indicated by the subband ID 705, the multiple data messages scheduled by the DCI message may follow an initial scheduling of an initial data message. For example, if the initial data message of the multiple data messages is indicated to be communicated using the first subband 535, each data message of the remaining data messages (such as all subsequent data messages of the multiple data messages scheduled by the DCI message) may (be expected to) be communicated using the first subband 535. By way of further example, if the initial data message of the multiple data messages is indicated to be communicated using the second subband 545, each data message of the remaining data messages (such as all subsequent data messages of the multiple data messages scheduled by the DCI message) may (be expected to) be communicated using the second subband 545. Using the subband information design 700, the UE 115 and the network entity 105 may efficiently communicate the subband information 565 via a DCI message and unambiguously determine which subband to use for each data message scheduled by the DCI message.

The subband ID 705 may indicate whether the multiple data messages are to be communicated using the first subband 535 or the second subband 545. In other words, the UE 115 and the network entity 105 may rely on (such as use) the subband ID 705 within the DCI message to distinguish between whether all the data messages are to be communicated using the first subband 535 (such as a “lower power state” subband) or are to be communicated using the second subband 545 (such as a “high power state” subband). In examples in which the subband ID 705 indicates an ID of “0,” the UE 115 may communicate the multiple data messages using the first subband 535. In examples in which the subband ID 705 indicates an ID of “1,” the UE 115 may communicate the multiple data messages using the second subband 545. In accordance with the subband information design 700, the UE 115 may not expect a mix of subbands. In other words, the UE 115 may expect that each data message of the multiple data messages is to be communicated using a same subband (in accordance with the UE 115 operating at a BWP including multiple subbands).

In accordance with the subband information design 725, the subband information 565 may include or be indicated by multiple FDRA fields, such as an FDRA field 730-a and an FDRA field 730-b. In such aspects in which the subband information 565 is included within or indicated by multiple FDRA fields, each FDRA field may correspond to a respective set of data messages of the multiple data messages scheduled by the DCI message. In some examples, each FDRA field may indicate, in conjunction with (such as together with, such as in a joint or collective manner) a time gap between two of the multiple data messages, which subband the UE 115 is to use to communicate the respective set of data messages. In such examples, the DCI message may exclude an explicit indication of which data messages of the multiple data messages use which subbands and may instead include different FDRA fields for the different subbands (such as for the different data message “states”). The UE 115 may rely on (such as use) a switching timeline (such as a time gap) and the FDRA fields to distinguish whether a data message is scheduled to be communicated using the first subband 535 or the second subband 545. Using the subband information design 725, the UE 115 and the network entity 105 may efficiently communicate the subband information 565 via a DCI message and unambiguously determine which subband to use for each data message scheduled by the DCI message.

For example, the FDRA field 730-a may be for (such as associated with or otherwise corresponding to) the first subband 535 and the FDRA field 730-b may be for (such as associated with or otherwise corresponding to) the second subband 545. The UE 115 may use one or both of the FDRA field 730-a or the FDRA field 730-b to determine which subband(s) (or which frequency domain resources within a determined subband) to use to communicate the multiple data messages in accordance with which subband the UE 115 uses to receive the DCI message, a first time gap between the DCI message and an initially scheduled data message, a second time gap between two consecutive data messages, or any combination thereof. By way of example, in scenarios in which the UE 115 receives the DCI message using the first subband 535, the UE 115 may communicate the initially scheduled data message using the first subband 535 and via frequency domain resources indicated by the FDRA field 730-a in accordance with the first time gap being less than a threshold time gap (such as less than 1 slot). By way of further example, in scenarios in which the UE 115 receives the DCI message using the first subband 535, the UE 115 may communicate the initially scheduled data message using the second subband 545 and via frequency domain resources indicated by the FDRA field 730-b in accordance with the first time gap being greater than or equal to the threshold time gap (such as greater than or equal to 1 slot).

By way of further example, in scenarios in which the UE 115 communicates a first data message (which may be an initially scheduled data message or may not be the initially scheduled data message) using frequency domain resources within the first subband 535 as indicated by the FDRA field 730-a, the UE 115 may communicate a second data message (such as a next data message after the first data message) using frequency domain resources within the first subband 535 as indicated by the FDRA field 730-a in accordance with a time gap between the first data message and the second data message being less than a threshold time gap (such as less than 1 slot). By way of further example, in scenarios in which the UE 115 communicates a first data message (which may be an initially scheduled data message or may not be the initially scheduled data message) using frequency domain resources within the first subband 535 as indicated by the FDRA field 730-a, the UE 115 may communicate a second data message (such as a next data message after the first data message) using frequency domain resources within the second subband 545 as indicated by the FDRA field 730-b in accordance with a time gap between the first data message and the second data message being greater than or equal to the threshold time gap (such as greater than or equal to 1 slot). Thus, the UE 115 may determine whether to use the FDRA field 730-a or the FDRA field 730-b to determine a set of frequency domain resources to use to communicate a data message depending on a time gap prior to that data message, depending on which subband was used to communicate an immediately prior data message or the DCI message, or depending on a combination thereof.

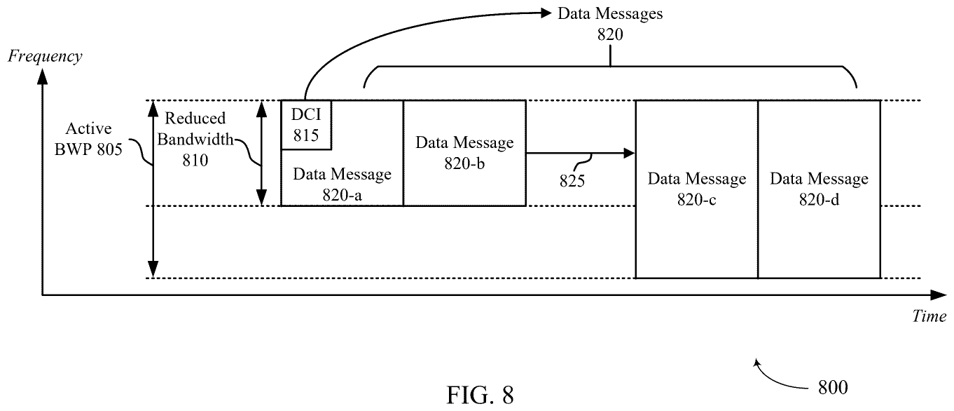

FIG. 8 shows an example of a communication timeline 800 in which a single DCI message schedules multiple data messages with light adaptation between subbands and with a sufficient subband switching time for a subband switch. The communication timeline 800 may implement or be implemented to realize one or more aspects of the wireless communications system 100, the subband configuration 200, the communication timeline 300, the communication timeline 325, the communication timeline 400, the signaling diagram 500, the subband information design 600, the subband information design 625, the subband information design 700, or the subband information design 725. For example, the communication timeline 800 illustrates communication between a UE 115 and a network entity 105, which may be examples of corresponding devices as illustrated and described herein.

For example, the UE 115 and the network entity 105 may communicate via an active BWP 805. In some implementations, the UE 115 and the network entity 105 may support multiple subbands within the active BWP 805. In such implementations, a first subband (such as the first subband 535) may be associated with a first bandwidth (such as a first valid quantity of PRBs) and a second subband (such as the second subband 545) may be associated with a second bandwidth (such as a second valid quantity of PRBs). In some examples, the first bandwidth may be a reduced bandwidth 810 and the second bandwidth may be a full bandwidth of the active BWP 805. In such examples, the first subband may be a subset of the second subband. In other words, the first valid quantity of PRBs may be a subset of the second valid quantity of PRBs. The full bandwidth of the active BWP 805 may be understood or referred to as a carrier bandwidth. The reduced bandwidth 810 may be associated with a low power state, a low RF state, or a low baseband state (such as an RF and a baseband matched to 20 MHz). The full bandwidth of the active BWP 805 may be associated with a high power state, a high RF state, or a high baseband state (such as an RF and a baseband matched to 100 MHz).

In accordance with the communication timeline 800, the UE 115 may receive, from the network entity 105, a DCI message 815 that schedules multiple data messages 820. The multiple data messages 820 may include a data message 820-a, a data message 820-b, a data message 820-c, and a data message 820-d. Although the communication timeline 800 illustrates an example in which the multiple data messages 820 include four data messages, the multiple data messages 820 may include any quantity of two or more data messages without exceeding the scope of the present disclosure.

In some implementations, the UE 115 and the network entity 105 may support one or more signaling- or configuration-based mechanisms according to which the network entity 105 may provide a sufficient subband switching time (such as a sufficient subband switching timeline) to accommodate the UE 115 switching between subbands (such as between the reduced bandwidth 810 and the full bandwidth of the active BWP 805). The subband switching time may be understood or referred to as an RF retune time or timeline. Such a sufficient subband switching time may define a lower limit amount of time between two consecutive (such as successive) data messages of the multiple data messages 820 that use different subbands. The subband switching time may be a quantity of slots (such as 1 slot or 2 slots, among other examples) or a quantity of symbols (such as 1 symbol, 2 symbols, or 3 symbols, among other examples). The subband switching time may be associated with a capability of the UE 115. In some examples, the UE 115 may transmit an indication of the subband switching time to the network entity 105. Additionally, or alternatively, the subband switching time may be defined by a network specification. Use of the subband switching time may result in a greater likelihood of successful communication between the UE 115 and the network entity 105, which may increase data rates and support greater system capacity.

In accordance with resource allocation information and subband information within the DCI message 815, the UE 115 may use the reduced bandwidth 810 to communicate the data message 820-a and the data message 820-b and may use the full bandwidth of the active BWP 805 to communicate the data message 820-c and the data message 820-d. In such examples, the network entity 105 may indicate, via the DCI message 815, time domain resources for the multiple data messages 820 such that the allocated time domain resources are in accordance with (such as comply with or satisfy) the switching time between the data message 820-b and the data message 820-c. In other words, the network entity 105 may indicate a time gap 825 between the data message 820-b and the data message 820-c that is equal to or greater than a sufficient subband switching time. The time gap 825 (which may be understood or referred to as a timeline to switch subbands) may be defined from a last symbol of the data message 820-b to an initial symbol of the data message 820-c.

In some examples, the network entity 105 may indicate the time gap 825 via the DCI message 815. For example, the DCI message 815 may include a field or one or more bits that explicitly indicate the time gap 825. Additionally, or alternatively, a TDRA field of the DCI message 815 may indicate (such as by indicating an entry into a TDRA table) a set of time domain resources to be used to communicate the multiple data messages 820, with a starting time for the data message 820-c being offset from the last symbol of the data message 820-b by the time gap 825 (per the indicated entry into the TDRA table).

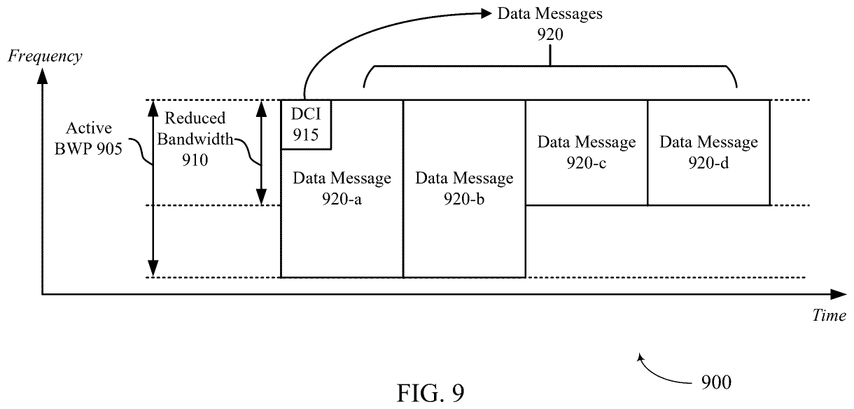

FIG. 9 shows an example of a communication timeline 900 in which a single DCI message schedules multiple data messages with light adaptation between subbands and without a subband switching time for a subband switch. The communication timeline 900 may implement or be implemented to realize one or more aspects of the wireless communications system 100, the subband configuration 200, the communication timeline 300, the communication timeline 325, the communication timeline 400, the signaling diagram 500, the subband information design 600, the subband information design 625, the subband information design 700, or the subband information design 725. For example, the communication timeline 900 illustrates communication between a UE 115 and a network entity 105, which may be examples of corresponding devices as illustrated and described herein.

For example, the UE 115 and the network entity 105 may communicate via an active BWP 905. In some implementations, the UE 115 and the network entity 105 may support multiple subbands within the active BWP 905. In such implementations, a first subband (such as the first subband 535) may be associated with a first bandwidth (such as a first valid quantity of PRBs) and a second subband (such as the second subband 545) may be associated with a second bandwidth (such as a second valid quantity of PRBs). In some examples, the first bandwidth may be a reduced bandwidth 910 and the second bandwidth may be a full bandwidth of the active BWP 905. In such examples, the first subband may be a subset of the second subband. In other words, the first valid quantity of PRBs may be a subset of the second valid quantity of PRBs. The full bandwidth of the active BWP 905 may be understood or referred to as a carrier bandwidth. The reduced bandwidth 910 may be associated with a low power state, a low RF state, or a low baseband state (such as an RF and a baseband matched to 20 MHz). The full bandwidth of the active BWP 905 may be associated with a high power state, a high RF state, or a high baseband state (such as an RF and a baseband matched to 100 MHz).

In accordance with the communication timeline 900, the UE 115 may receive, from the network entity 105, a DCI message 915 that schedules multiple data messages 920. The multiple data messages 920 may include a data message 920-a, a data message 920-b, a data message 920-c, and a data message 920-d. Although the communication timeline 900 illustrates an example in which the multiple data messages 920 include four data messages, the multiple data messages 920 may include any quantity of two or more data messages without exceeding the scope of the present disclosure. In accordance with resource allocation information and subband information within the DCI message 915, the UE 115 may communicate the data message 920-a and the data message 920-b using the full bandwidth of the active BWP 905 and may communicate the data message 920-c and the data message 920-d using the reduced bandwidth 910.

In some implementations, the UE 115 and the network entity 105 may refrain from expecting or scheduling a subband switching time in scenarios in which the UE 115 switches from the full bandwidth of the active BWP 905 to the reduced bandwidth 910 and in which the reduced bandwidth 910 is a subset of the full bandwidth of the active BWP 905. In other words, the UE 115 and the network entity 105 may refrain from scheduling or expecting a subband switching time in scenarios in which an initially used subband fully includes a subsequently used subband. By way of further example, if low power state RBs (such as a low power state bandwidth) are a subset of high power state RBs (such as a high power state bandwidth), the UE 115 and the network entity 105 may not expect or schedule a subband switching time (such that the subband switching time may be equal to zero).

Alternatively, the UE 115 and the network entity 105 may expect or schedule a subband switching time in scenarios in which an initially used subband does not fully include a subsequently used subband. In other words, if low power state RBs (such as a low power state bandwidth) are at least partially non-overlapping with high power state RBs (such as a high power state bandwidth), the UE 115 and the network entity 105 may expect or schedule a subband switching time (such that the subband switching time may be greater than zero). The UE 115 and the network entity 105 may expect or schedule a subband switching time in such scenarios because the UE 115 may be unable to directly switch between subbands that are at least partially non-overlapping and may use at least a (UE capability-based) subband switching time to perform the subband switch. Such a selective use of the subband switching time may result in a greater likelihood of successful communication between the UE 115 and the network entity 105 while balancing overall performance, which may increase data rates and support greater system capacity.

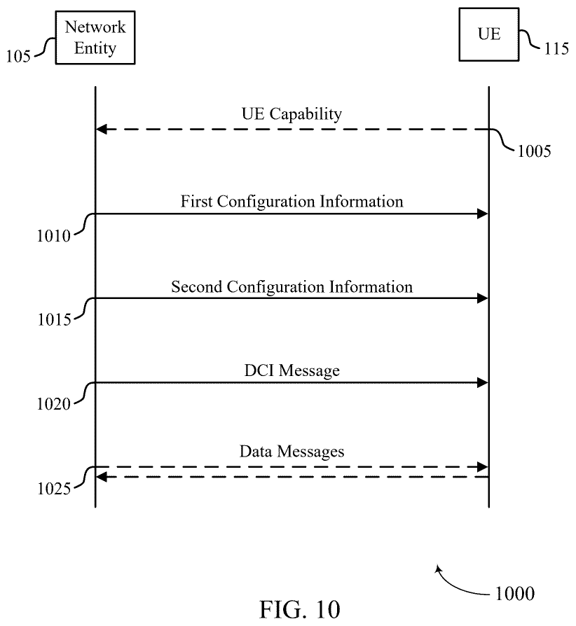

FIG. 10 shows an example of a process flow 1000 illustrative of signaling between a UE 115 and a network entity 105 that supports scheduling multiple data messages with light adaptation between subbands of an active BWP using a single DCI message. The process flow 1000 may implement or be implemented to realize one or more aspects of the wireless communications system 100, the subband configuration 200, the communication timeline 300, the communication timeline 325, the communication timeline 400, the signaling diagram 500, the subband information design 600, the subband information design 625, the subband information design 700, the subband information design 725, the communication timeline 800, or the communication timeline 900. For example, the process flow 1000 illustrates communication between a UE 115 and a network entity 105, which may be examples of corresponding devices as illustrated and described herein.

In the following description of the process flow 1000, the communications between the UE 115 and the network entity 105 may be transmitted in a different order than the example order shown, or the operations performed by the UE 115 and the network entity 105 may be performed in different orders or at different times. Some operations may also be omitted from the process flow 1000, and other operations may be added to the process flow 1000.

At 1005, the UE 115 may transmit information indicative of a capability of the UE 115. Such information may indicate whether the UE 115 is capable of supporting multiple subbands within an active BWP, timeline (such as slot offset) or processing capabilities of the UE 115, or field interpretations supported by the UE 115, among other examples. The UE 115 may transmit such information indicative of the UE capability via RRC signaling, one or more MAC-CEs, one or more UCI messages, or any combination thereof. In some aspects, the information may include an indication of a subband switching time. In some aspects, the information may include an indication of a threshold quantity of (such as an upper limit of) subband switches across data messages scheduled by a same DCI message.

At 1010, the UE 115 may receive, from the network entity 105, first configuration information. The first configuration information that the UE 115 receives at 1010 may be an example of the first configuration information 515 as illustrated by and described with reference to FIG. 5. The first configuration information may indicate a respective set of parameters associated with each BWP of one or more BWPs configured at the UE 115, including a set of parameters associated with an active BWP of the UE 115 (such as the set of parameters 525 associated with the active BWP 520 as illustrated by and described with reference to FIG. 5).

At 1015, the UE 115 may receive, from the network entity 105, second configuration information. The second configuration information that the UE 115 receives at 1015 may be an example of the second configuration information 530 as illustrated by and described with reference to FIG. 5. The second configuration information may indicate multiple subbands of different valid quantities of PRBs within the active BWP. For example, the UE 115 may receive the second configuration information as part of (such as within) the first configuration information. In other words, the first configuration information may include a set of parameters, fields, or information elements, with a subset of the set of parameters, fields, or information elements providing the second configuration information. The multiple subbands with the different valid quantities of PRBs may include the first subband 535 and the second subband 545, as illustrated by and described with reference to FIG. 5.

At 1020, the UE 115 may receive, from the network entity 105, a DCI message. The DCI message that the UE 115 receives at 1020 may be an example of the DCI message 555 as illustrated by and described with reference to FIG. 5, the DCI message 815 as illustrated by and described with reference to FIG. 8, or the DCI message 915 as illustrated by and described with reference to FIG. 9. The DCI message may include resource allocation information (such as the resource allocation information 560 as illustrated by and described with reference to FIG. 5) associated with multiple data messages and may include subband information (such as subband information 565 as illustrated by and described with reference to FIG. 5, 6A, 6B, 7A, or 7B) indicative of which subband the UE 115 is to use to communicate each data message of the multiple data messages.

The DCI message may be associated with a DCI format 1_1 or a DCI format 0_1 that schedules multiple data messages per slot or over a set of slots. Each data message may be confined within a slot and, in some examples, may be absent of repetition. In some examples, a time gap between adjacent (such as consecutive or successive) data messages may be allowed, potentially including slot level time gaps. In some examples, there may be no upper limit time gap limitation, except those from (such as indicated or dictated by) a range of RRC parameters. In some examples, a row of a TDRA table (as indicated by or pointed to by a TDRA field within the DCI message) may indicate data messages that are in consecutive or non-consecutive slots by configuring {SLIV, mapping type, scheduling offset K0 or K2} for each data message in the row of the TDRA table. A scheduling offset K0 may indicate a time slot offset between a slot in which the DCI message is received and a slot in which a downlink data message is received. A scheduling offset K2 may indicate a time slot offset between a slot in which the DCI message is received and a slot in which an uplink data message is transmitted.

The DCI message may include one or multiple FDRA fields and, in some implementations, the UE 115 may parse or interpret the FDRA field(s) in accordance with the subband information. For example, the UE 115 may separately interpret an FDRA field for each data message of the multiple data messages depending on which subband the UE 115 is to use to communicate that data message. By way of example, the UE 115 may interpret an FDRA field in accordance with a first interpretation to determine a first frequency domain resource via which to communicate a first data message using a first subband. By way of further example, the UE 115 may interpret an FDRA field (the same FDRA field or another FDRA field) in accordance with a second interpretation to determine a second frequency domain resource via which to communicate a second data message using a second subband. The UE 115 may perform such FDRA field interpretations for various resource allocation types, such as for a resource allocation type 1 (RIV-based resource allocation) or a resource allocation type 2 (RBG-based resource allocation), among other examples.

For example, the network entity 105 may indicate, via the DCI message, the UE 115 to use a high power state subband to communicate a first data message and, in such examples, the UE 115 may interpret an FDRA field to determine a scheduling of the first data message over a first set of PRBs associated with the high power state subband (such as all RBs within an active BWP). By way of further example, the network entity 105 may indicate, via the DCI message, the UE 115 to use a low power state subband to communicate a second data message and, in such examples, the UE 115 may interpret an FDRA field (the same FDRA field or another FDRA field) to determine a scheduling of the second data message over a second set of PRBs associated with the low power state subband (such that the scheduled RBs are within a restricted bandwidth of the active BWP). Thus, the UE 115 may interpret one or more FDRA fields within a same DCI message in multiple ways in examples in which the UE 115 is indicated to use different subbands to communicate multiple data messages scheduled by the network entity 105 using the same DCI message.

In examples in which all data messages are scheduled to be communicated using a low power state subband, the UE 115 may interpret the FDRA field(s) of all the data messages in a same or similar manner (such that some FDRA/RIV field values may not be expected, per a scheduling expectation or restriction associated with the low power state subband). In examples in which all data messages are scheduled to be communicated using a high power state subband, the UE 115 may interpret the FDRA field(s) of all the data messages in a same or similar manner (such that all FDRA/RIV values may be expected by the UE 115 to be valid, such as in the absence of a scheduling expectation or restriction associated with the high power state subband).

At 1025, the UE 115 may communicate (such as transmit or receive), with the network entity 105, the multiple data messages. The UE 115 may communicate the multiple data message in accordance with the resource allocation information and the subband information included within the DCI message. For example, the UE 115 may communicate each data message of the multiple data messages via a respective set of frequency domain resources indicated by one or more FDRA fields in accordance with the subband information indicating which subband the UE 115 is to use to communicate each data message of the multiple data messages. The multiple data messages may include downlink data messages or uplink data messages.

Additionally, or alternatively, the DCI message may schedule a data message with repetition. For a data message (such as a PDSCH data message or a PUSCH data message) with repetition or for a combination of data messages at different power states (such as different subbands, such as a relatively wider subband and a relatively narrower subband), the UE 115 or the network entity 105, or both, may employ one or more techniques associated with TB size (TBS) determination. In some implementations, for example, the UE 115 or the network entity 105, or both, may calculate a TBS in accordance with a valid quantity of PRBs and allow for repetition across subbands. In some other implementations, the UE 115 or the network entity 105, or both, may calculate a TBS in accordance with a downlink slot with an absence of scheduling restrictions (such as a downlink slot within which the UE 115 uses a relatively wider subband). In some other implementations, the UE 115 or the network entity 105, or both, may not expect or schedule repetition across subbands. The UE 115 and the network entity 105 may provide (such as transmit or receive) an indication of one or more of such implementations via signaling, such as part of a semi-static configuration. For example, a CG configuration with a repK parameter or semi-persistent scheduling (SPS) with repetition may provide an indication of one or more of such implementations.

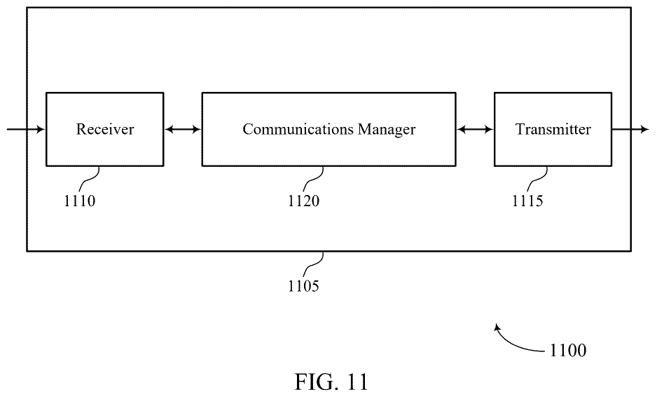

FIG. 11 shows a block diagram 1100 of a device 1105 that supports scheduling multiple data messages with light adaptation between subbands of an active BWP using a single DCI message. The device 1105 may be an example of aspects of a UE 115 as described herein. The device 1105 may include a receiver 1110, a transmitter 1115, and a communications manager 1120. The device 1105, or one or more components of the device 1105 (such as the receiver 1110, the transmitter 1115, the communications manager 1120), may include at least one processor, which may be coupled with at least one memory, to, individually or collectively, support or enable the described techniques. Each of these components may be in communication with one another (such as via one or more buses).

The receiver 1110 may provide a means for receiving information such as packets, user data, control information, or any combination thereof associated with various information channels (such as control channels, data channels, information channels related to scheduling multiple data messages with light adaptation between subbands of an active BWP using a single DCI message). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (such as control channels, data channels, information channels related to scheduling multiple data messages with light adaptation between subbands of an active BWP using a single DCI message). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations or components thereof may be examples of means for performing various aspects of scheduling multiple data messages with light adaptation between subbands of an active BWP using a single DCI message as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (such as in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 1120, the receiver 1110, the transmitter 1115, or various combinations or components thereof may be implemented in code (such as communications management software or firmware) executed by at least one processor (such as referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, a GPU, an NPU, an ASIC, an FPGA, a microcontroller, or any combination of these or other programmable logic devices (such as configured as or otherwise supporting, individually or collectively, a means for performing the functions described in the present disclosure).

In some examples, the communications manager 1120 may be configured to perform various operations (such as receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for receiving first configuration information indicative of a set of parameters associated with an active BWP of the UE and, as part of the first configuration information, second configuration information indicative of a set of multiple subbands within the active BWP, the set of multiple subbands including different valid quantities of PRBs. The communications manager 1120 is capable of, configured to, or operable to support a means for receiving a DCI message that includes resource allocation information associated with a set of multiple data messages and includes subband information indicative of which subband of the set of multiple subbands the UE is to use to communicate each data message of the set of multiple data messages. The communications manager 1120 is capable of, configured to, or operable to support a means for communicating the set of multiple data messages using at least one subband of the set of multiple subbands in accordance with the resource allocation information and the subband information.

By including or configuring the communications manager 1120 in accordance with examples as described herein, the device 1105 (such as at least one processor controlling or otherwise coupled with the receiver 1110, the transmitter 1115, the communications manager 1120, or a combination thereof) may support techniques for reduced processing, reduced power consumption, and more efficient utilization of communication resources.

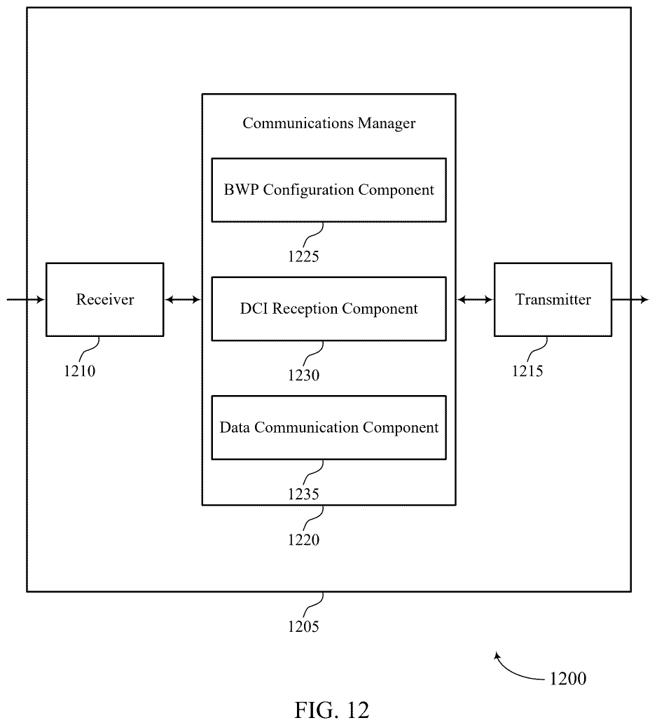

FIG. 12 shows a block diagram 1200 of a device 1205 that supports scheduling multiple data messages with light adaptation between subbands of an active BWP using a single DCI message. The device 1205 may be an example of aspects of a device 1105 or a UE 115 as described herein. The device 1205 may include a receiver 1210, a transmitter 1215, and a communications manager 1220. The device 1205, or one or more components of the device 1205 (such as the receiver 1210, the transmitter 1215, the communications manager 1220), may include at least one processor, which may be coupled with at least one memory, to support the described techniques. Each of these components may be in communication with one another (such as via one or more buses).

The receiver 1210 may provide a means for receiving information such as packets, user data, control information, or any combination thereof associated with various information channels (such as control channels, data channels, information channels related to scheduling multiple data messages with light adaptation between subbands of an active BWP using a single DCI message). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (such as control channels, data channels, information channels related to scheduling multiple data messages with light adaptation between subbands of an active BWP using a single DCI message). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of scheduling multiple data messages with light adaptation between subbands of an active BWP using a single DCI message as described herein. For example, the communications manager 1220 may include a BWP configuration component 1225, a DCI reception component 1230, a data communication component 1235, or any combination thereof. The communications manager 1220 may be an example of aspects of a communications manager 1120 as described herein. In some examples, the communications manager 1220, or various components thereof, may be configured to perform various operations (such as receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The BWP configuration component 1225 is capable of, configured to, or operable to support a means for receiving first configuration information indicative of a set of parameters associated with an active BWP of the UE and, as part of the first configuration information, second configuration information indicative of a set of multiple subbands within the active BWP, the set of multiple subbands including different valid quantities of PRBs. The DCI reception component 1230 is capable of, configured to, or operable to support a means for receiving a DCI message that includes resource allocation information associated with a set of multiple data messages and includes subband information indicative of which subband of the set of multiple subbands the UE is to use to communicate each data message of the set of multiple data messages. The data communication component 1235 is capable of, configured to, or operable to support a means for communicating the set of multiple data messages using at least one subband of the set of multiple subbands in accordance with the resource allocation information and the subband information.

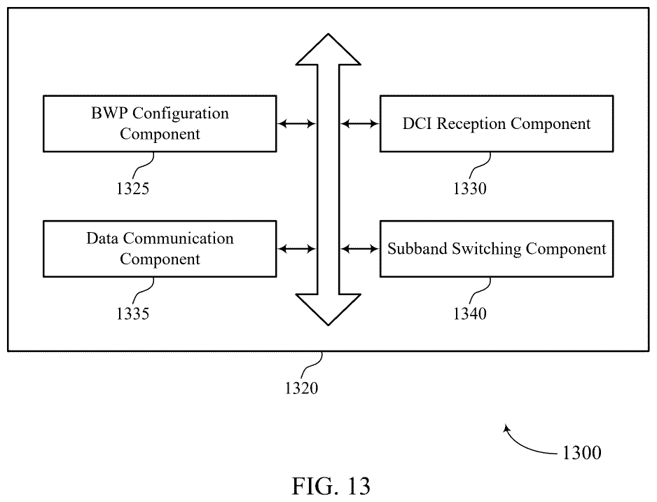

FIG. 13 shows a block diagram 1300 of a communications manager 1320 that supports scheduling multiple data messages with light adaptation between subbands of an active BWP using a single DCI message. The communications manager 1320 may be an example of aspects of a communications manager 1120, a communications manager 1220, or both, as described herein. The communications manager 1320, or various components thereof, may be an example of means for performing various aspects of scheduling multiple data messages with light adaptation between subbands of an active BWP using a single DCI message as described herein. For example, the communications manager 1320 may include a BWP configuration component 1325, a DCI reception component 1330, a data communication component 1335, a subband switching component 1340, or any combination thereof. Each of these components, or components or subcomponents thereof (such as one or more processors, one or more memories), may communicate, directly or indirectly, with one another (such as via one or more buses).

The communications manager 1320 may support wireless communications in accordance with examples as disclosed herein. The BWP configuration component 1325 is capable of, configured to, or operable to support a means for receiving first configuration information indicative of a set of parameters associated with an active BWP of the UE and, as part of the first configuration information, second configuration information indicative of a set of multiple subbands within the active BWP, the set of multiple subbands including different valid quantities of PRBs. The DCI reception component 1330 is capable of, configured to, or operable to support a means for receiving a DCI message that includes resource allocation information associated with a set of multiple data messages and includes subband information indicative of which subband of the set of multiple subbands the UE is to use to communicate each data message of the set of multiple data messages. The data communication component 1335 is capable of, configured to, or operable to support a means for communicating the set of multiple data messages using at least one subband of the set of multiple subbands in accordance with the resource allocation information and the subband information.

In some examples, the subband switching component 1340 is capable of, configured to, or operable to support a means for transmitting an indication of a subband switching time associated with the set of multiple subbands, the resource allocation information associated with the set of multiple data messages being in accordance with the subband switching time. In some examples, the subband switching time is associated with a capability of the UE.

In some examples, the set of multiple subbands includes a first subband and a second subband. In some examples, the first subband includes a first valid quantity of PRBs and the second subband includes a second valid quantity of PRBs that is greater than the first valid quantity of PRBs. In some examples, the subband switching time defines a lower limit amount of time between a first data message of the set of multiple data messages that uses the first subband and a second data message of the set of multiple data messages that uses the second subband.

In some examples, the set of multiple subbands includes a first subband and a second subband that are non-overlapping. In some examples, the first subband includes a first valid quantity of PRBs and the second subband includes a second valid quantity of PRBs that is greater than the first valid quantity of PRBs. In some examples, the subband switching time defines a lower limit amount of time between a first data message of the set of multiple data messages that uses the second subband and a second data message of the set of multiple data messages that uses the first subband.

In some examples, the DCI message indicates a time gap between a first data message of the set of multiple data messages and a second data message of the set of multiple data messages. In some examples, the time gap is in accordance with the subband switching time.

In some examples, the subband information includes a bitmap. In some examples, each bit of the bitmap corresponds to a respective data message of the set of multiple data messages and indicates which subband of the set of multiple subbands the UE is to use to communicate the respective data message.

In some examples, a first bit value indicates the UE to use a first subband of the set of multiple subbands to communicate a corresponding data message and a second bit value indicates the UE to use a second subband of the set of multiple subbands to communicate the corresponding data message.

In some examples, the subband information includes a field. In some examples, different codepoints of the field indicate different subband patterns the UE is to use to communicate the set of multiple data messages.

In some examples, a first codepoint of the field indicates the UE to use a first subband of the set of multiple subbands to communicate the set of multiple data messages. In some examples, a second codepoint of the field indicates the UE to use the first subband of the set of multiple subbands to communicate a first quantity of the set of multiple data messages and to use a second subband of the set of multiple subbands to communicate a second quantity of the set of multiple data messages. In some examples, a third codepoint of the field indicates the UE to use the second subband of the set of multiple subbands to communicate the set of multiple data messages.

In some examples, the subband information includes a subband ID. In some examples, the subband ID indicates which subband of the set of multiple subbands the UE is to use to communicate the set of multiple data messages.

In some examples, the subband information includes a set of multiple FDRA fields. In some examples, each FDRA field corresponds to a respective set of the set of multiple data messages and indicates, in conjunction with a time gap between a first data message of the set of multiple data messages and a second data message of the set of multiple data messages, which subband of the set of multiple subbands the UE is to use to communicate the respective set of the set of multiple data messages.

In some examples, the subband information is in accordance with an upper limit quantity of subband switches. In some examples, the upper limit quantity of subband switches is associated with one or both of a capability of the UE or a network protocol. In some examples, the upper limit quantity of subband switches includes zero subband switches, a single subband switch, or two or more subband switches.

In some examples, the subband switching component 1340 is capable of, configured to, or operable to support a means for transmitting an indication of the upper limit quantity of subband switches in accordance with the upper limit quantity of subband switches being associated with the capability of the UE.

In some examples, the subband information indicates the UE to use a first subband of the set of multiple subbands to communicate a first set of data messages of the set of multiple data messages and to use a second subband of the set of multiple subbands to communicate a second set of data messages of the set of multiple data messages. In some examples, a time domain order of the first set of data messages and the second set of data messages is in accordance with a scheduling expectation that there is a single subband switch across the set of multiple data messages.

In some examples, the resource allocation information associated with the set of multiple data messages is at least in part associated with an FDRA field. In some examples, an interpretation of the FDRA field is in accordance with the subband information.

In some examples, the subband information indicates the UE to use a first subband of the set of multiple subbands to communicate a first data message of the set of multiple data messages and to use a second subband of the set of multiple subbands to communicate a second data message of the set of multiple data messages. In some examples, the interpretation of the FDRA field is a first interpretation to obtain a first FDRA associated with the first data message, the first interpretation associated with the first subband. In some examples, the interpretation of the FDRA field is a second interpretation to obtain a second FDRA associated with the second data message, the second interpretation associated with the second subband.

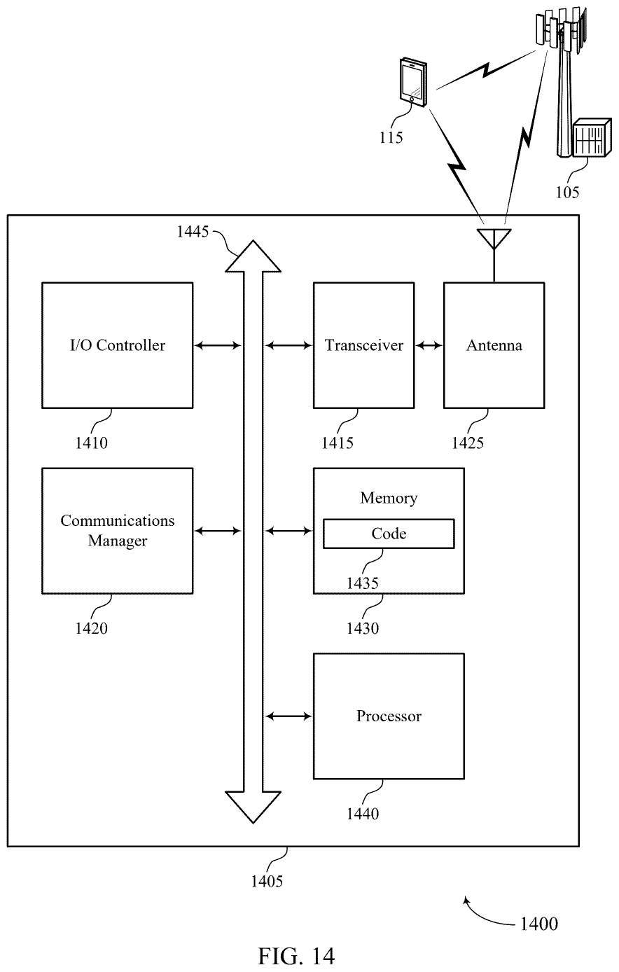

FIG. 14 shows a diagram of a system 1400 including a device 1405 that supports scheduling multiple data messages with light adaptation between subbands of an active BWP using a single DCI message. The device 1405 may be an example of or include components of a device 1105, a device 1205, or a UE 115 as described herein. The device 1405 may communicate (such as wirelessly) with one or more other devices (such as network entities 105, UEs 115, or a combination thereof). The device 1405 may include components for bi-directional voice and data communications including components for transmitting and receiving communications, such as a communications manager 1420, an input/output (I/O) controller, such as an I/O controller 1410, a transceiver 1415, one or more antennas 1425, at least one memory 1430, code 1435, and at least one processor 1440. These components may be in electronic communication or otherwise coupled (such as operatively, communicatively, functionally, electronically, electrically) via one or more buses (such as a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna. However, in some other cases, the device 1405 may have more than one antenna, which may be capable of concurrently transmitting or receiving multiple wireless transmissions. The transceiver 1415 may communicate bi-directionally via the one or more antennas 1425 using wired or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include random access memory (RAM) and read-only memory (ROM). The at least one memory 1430 may store computer-readable, computer-executable, or processor-executable code, such as the code 1435. The code 1435 may include instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (such as when compiled and executed) to perform functions described herein. In some cases, the at least one memory 1430 may include, among other things, a basic I/O system (BIOS) which may control basic hardware or software operation such as the interaction with peripheral components or devices.

The at least one processor 1440 may include one or more intelligent hardware devices (such as one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (such as the at least one memory 1430) to cause the device 1405 to perform various functions (such as functions or tasks supporting scheduling multiple data messages with light adaptation between subbands of an active BWP using a single DCI message). For example, the device 1405 or a component of the device 1405 may include at least one processor 1440 and at least one memory 1430 coupled with or to the at least one processor 1440, the at least one processor 1440 and the at least one memory 1430 configured to perform various functions described herein.

In some examples, the at least one processor 1440 may include multiple processors and the at least one memory 1430 may include multiple memories. One or more of the multiple processors may be coupled with one or more of the multiple memories, which may, individually or collectively, be configured to perform various functions described herein. In some examples, the at least one processor 1440 may be a component of a processing system, which may refer to a system (such as a series) of machines, circuitry (including, for example, one or both of processor circuitry (which may include the at least one processor 1440) and memory circuitry (which may include the at least one memory 1430)), or components, that receives or obtains inputs and processes the inputs to produce, generate, or obtain a set of outputs. The processing system may be configured to perform one or more of the functions described herein. For example, the at least one processor 1440 or a processing system including the at least one processor 1440 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code 1435 (such as processor-executable code) stored in the at least one memory 1430 or otherwise, to perform one or more of the functions described herein. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

The communications manager 1420 may support wireless communications in accordance with examples as disclosed herein. For example, the communications manager 1420 is capable of, configured to, or operable to support a means for receiving first configuration information indicative of a set of parameters associated with an active BWP of the UE and, as part of the first configuration information, second configuration information indicative of a set of multiple subbands within the active BWP, the set of multiple subbands including different valid quantities of PRBs. The communications manager 1420 is capable of, configured to, or operable to support a means for receiving a DCI message that includes resource allocation information associated with a set of multiple data messages and includes subband information indicative of which subband of the set of multiple subbands the UE is to use to communicate each data message of the set of multiple data messages. The communications manager 1420 is capable of, configured to, or operable to support a means for communicating the set of multiple data messages using at least one subband of the set of multiple subbands in accordance with the resource allocation information and the subband information.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1420 may be configured to perform various operations (such as receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of scheduling multiple data messages with light adaptation between subbands of an active BWP using a single DCI message as described herein, or the at least one processor 1440 and the at least one memory 1430 may be otherwise configured to, individually or collectively, perform or support such operations.

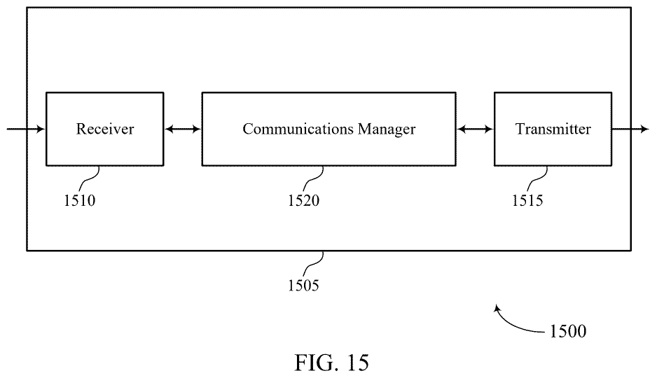

FIG. 15 shows a block diagram 1500 of a device 1505 that supports scheduling multiple data messages with light adaptation between subbands of an active BWP using a single DCI message. The device 1505 may be an example of aspects of a network entity 105 as described herein. The device 1505 may include a receiver 1510, a transmitter 1515, and a communications manager 1520. The device 1505, or one or more components of the device 1505 (such as the receiver 1510, the transmitter 1515, the communications manager 1520), may include at least one processor, which may be coupled with at least one memory, to, individually or collectively, support or enable the described techniques. Each of these components may be in communication with one another (such as via one or more buses).

The receiver 1510 may provide a means for obtaining (such as receiving, determining, identifying) information such as user data, control information, or any combination thereof (such as I/Q samples, symbols, packets, protocol data units, service data units) associated with various channels (such as control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (such as electrical, fiber optic) interfaces, wireless interfaces, or any combination thereof.

The transmitter 1515 may provide a means for outputting (such as transmitting, providing, conveying, sending) information generated by other components of the device 1505. For example, the transmitter 1515 may output information such as user data, control information, or any combination thereof (such as I/Q samples, symbols, packets, protocol data units, service data units) associated with various channels (such as control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (such as electrical, fiber optic) interfaces, wireless interfaces, or any combination thereof. In some examples, the transmitter 1515 and the receiver 1510 may be co-located in a transceiver, which may include or be coupled with a modem.

The communications manager 1520, the receiver 1510, the transmitter 1515, or various combinations or components thereof may be examples of means for performing various aspects of scheduling multiple data messages with light adaptation between subbands of an active BWP using a single DCI message as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (such as in communications management circuitry). The hardware may include at least one of a processor, a DSP, a CPU, a GPU, an NPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 1520, the receiver 1510, the transmitter 1515, or various combinations or components thereof may be implemented in code (such as s communications management software or firmware) executed by at least one processor (such as referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, a GPU, an NPU, an ASIC, an FPGA, a microcontroller, or any combination of these or other programmable logic devices (such as configured as or otherwise supporting, individually or collectively, a means for performing the functions described in the present disclosure).

In some examples, the communications manager 1520 may be configured to perform various operations (such as receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. For example, the communications manager 1520 is capable of, configured to, or operable to support a means for outputting first configuration information indicative of a set of parameters associated with an active BWP of a UE and, as part of the first configuration information, second configuration information indicative of a set of multiple subbands within the active BWP, the set of multiple subbands including different valid quantities of PRBs. The communications manager 1520 is capable of, configured to, or operable to support a means for outputting a DCI message that includes resource allocation information associated with a set of multiple data messages and includes subband information indicative of which subband of the set of multiple subbands the UE is to use to communicate each data message of the set of multiple data messages. The communications manager 1520 is capable of, configured to, or operable to support a means for communicating the set of multiple data messages using at least one subband of the set of multiple subbands in accordance with the resource allocation information and the subband information.

By including or configuring the communications manager 1520 in accordance with examples as described herein, the device 1505 (such as at least one processor controlling or otherwise coupled with the receiver 1510, the transmitter 1515, the communications manager 1520, or a combination thereof) may support techniques for reduced processing, reduced power consumption, and more efficient utilization of communication resources.

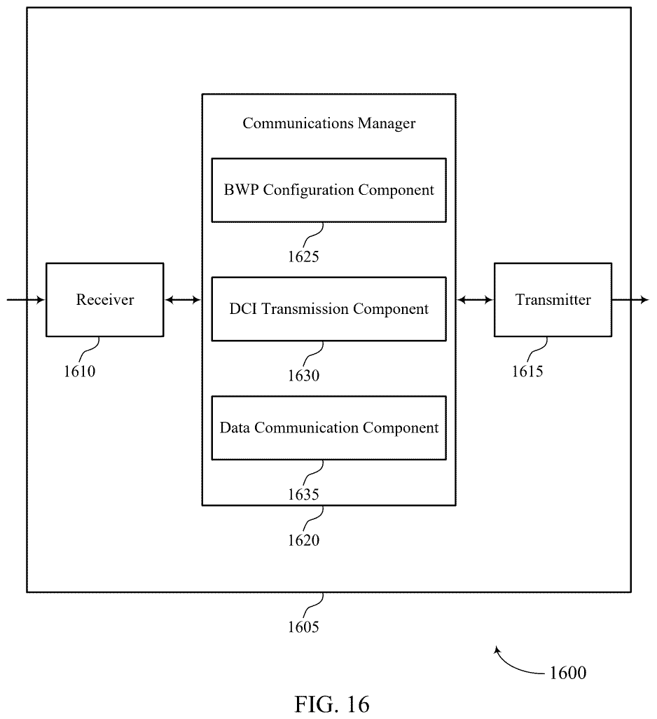

FIG. 16 shows a block diagram 1600 of a device 1605 that supports scheduling multiple data messages with light adaptation between subbands of an active BWP using a single DCI message. The device 1605 may be an example of aspects of a device 1505 or a network entity 105 as described herein. The device 1605 may include a receiver 1610, a transmitter 1615, and a communications manager 1620. The device 1605, or one or more components of the device 1605 (such as the receiver 1610, the transmitter 1615, the communications manager 1620), may include at least one processor, which may be coupled with at least one memory, to support the described techniques. Each of these components may be in communication with one another (such as via one or more buses).

The receiver 1610 may provide a means for obtaining (such as receiving, determining, identifying) information such as user data, control information, or any combination thereof (such as I/Q samples, symbols, packets, protocol data units, service data units) associated with various channels (such as control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (such as electrical, fiber optic) interfaces, wireless interfaces, or any combination thereof.

The transmitter 1615 may provide a means for outputting (such as transmitting, providing, conveying, sending) information generated by other components of the device 1605. For example, the transmitter 1615 may output information such as user data, control information, or any combination thereof (such as I/Q samples, symbols, packets, protocol data units, service data units) associated with various channels (such as control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (such as electrical, fiber optic) interfaces, wireless interfaces, or any combination thereof. In some examples, the transmitter 1615 and the receiver 1610 may be co-located in a transceiver, which may include or be coupled with a modem.

The device 1605, or various components thereof, may be an example of means for performing various aspects of scheduling multiple data messages with light adaptation between subbands of an active BWP using a single DCI message as described herein. For example, the communications manager 1620 may include a BWP configuration component 1625, a DCI transmission component 1630, a data communication component 1635, or any combination thereof. The communications manager 1620 may be an example of aspects of a communications manager 1520 as described herein. In some examples, the communications manager 1620, or various components thereof, may be configured to perform various operations (such as receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. The BWP configuration component 1625 is capable of, configured to, or operable to support a means for outputting first configuration information indicative of a set of parameters associated with an active BWP of a UE and, as part of the first configuration information, second configuration information indicative of a set of multiple subbands within the active BWP, the set of multiple subbands including different valid quantities of PRBs. The DCI transmission component 1630 is capable of, configured to, or operable to support a means for outputting a DCI message that includes resource allocation information associated with a set of multiple data messages and includes subband information indicative of which subband of the set of multiple subbands the UE is to use to communicate each data message of the set of multiple data messages. The data communication component 1635 is capable of, configured to, or operable to support a means for communicating the set of multiple data messages using at least one subband of the set of multiple subbands in accordance with the resource allocation information and the subband information.

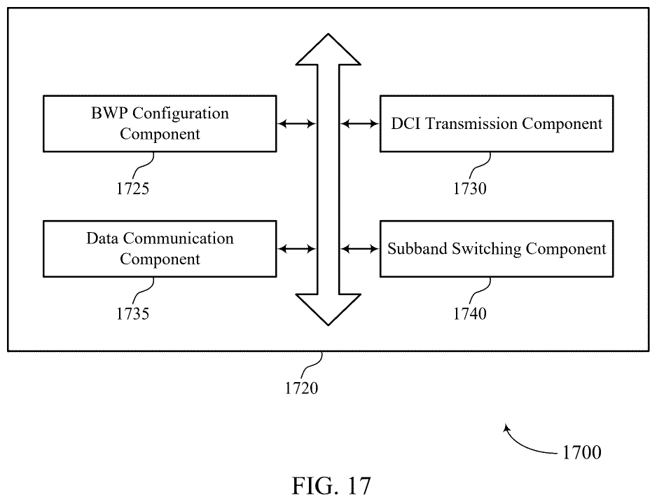

FIG. 17 shows a block diagram 1700 of a communications manager 1720 that supports scheduling multiple data messages with light adaptation between subbands of an active BWP using a single DCI message. The communications manager 1720 may be an example of aspects of a communications manager 1520, a communications manager 1620, or both, as described herein. The communications manager 1720, or various components thereof, may be an example of means for performing various aspects of scheduling multiple data messages with light adaptation between subbands of an active BWP using a single DCI message as described herein. For example, the communications manager 1720 may include a BWP configuration component 1725, a DCI transmission component 1730, a data communication component 1735, a subband switching component 1740, or any combination thereof. Each of these components, or components or subcomponents thereof (such as one or more processors, one or more memories), may communicate, directly or indirectly, with one another (such as via one or more buses). The communications may include communications within a protocol layer of a protocol stack, communications associated with a logical channel of a protocol stack (such as between protocol layers of a protocol stack, within a device, component, or virtualized component associated with a network entity 105, between devices, components, or virtualized components associated with a network entity 105), or any combination thereof.

The communications manager 1720 may support wireless communications in accordance with examples as disclosed herein. The BWP configuration component 1725 is capable of, configured to, or operable to support a means for outputting first configuration information indicative of a set of parameters associated with an active BWP of a UE and, as part of the first configuration information, second configuration information indicative of a set of multiple subbands within the active BWP, the set of multiple subbands including different valid quantities of PRBs. The DCI transmission component 1730 is capable of, configured to, or operable to support a means for outputting a DCI message that includes resource allocation information associated with a set of multiple data messages and includes subband information indicative of which subband of the set of multiple subbands the UE is to use to communicate each data message of the set of multiple data messages. The data communication component 1735 is capable of, configured to, or operable to support a means for communicating the set of multiple data messages using at least one subband of the set of multiple subbands in accordance with the resource allocation information and the subband information.

In some examples, the subband switching component 1740 is capable of, configured to, or operable to support a means for obtaining an indication of a subband switching time associated with the set of multiple subbands, the resource allocation information associated with the set of multiple data messages being in accordance with the subband switching time. In some examples, the subband switching time is associated with a capability of the UE.

In some examples, the set of multiple subbands includes a first subband and a second subband. In some examples, the first subband includes a first valid quantity of PRBs and the second subband includes a second valid quantity of PRBs that is greater than the first valid quantity of PRBs. In some examples, the subband switching time defines a lower limit amount of time between a first data message of the set of multiple data messages that uses the first subband and a second data message of the set of multiple data messages that uses the second subband.

In some examples, the set of multiple subbands includes a first subband and a second subband that are non-overlapping. In some examples, the first subband includes a first valid quantity of PRBs and the second subband includes a second valid quantity of PRBs that is greater than the first valid quantity of PRBs. In some examples, the subband switching time defines a lower limit amount of time between a first data message of the set of multiple data messages that uses the second subband and a second data message of the set of multiple data messages that uses the first subband.

In some examples, the DCI message indicates a time gap between a first data message of the set of multiple data messages and a second data message of the set of multiple data messages. In some examples, the time gap is in accordance with the subband switching time.

In some examples, the subband information includes a bitmap. In some examples, each bit of the bitmap corresponds to a respective data message of the set of multiple data messages and indicates which subband of the set of multiple subbands the UE is to use to communicate the respective data message.

In some examples, a first bit value indicates the UE to use a first subband of the set of multiple subbands to communicate a corresponding data message and a second bit value indicates the UE to use a second subband of the set of multiple subbands to communicate the corresponding data message.

In some examples, the subband information includes a field. In some examples, different codepoints of the field indicate different subband patterns the UE is to use to communicate the set of multiple data messages.

In some examples, a first codepoint of the field indicates the UE to use a first subband of the set of multiple subbands to communicate the set of multiple data messages. In some examples, a second codepoint of the field indicates the UE to use the first subband of the set of multiple subbands to communicate a first quantity of the set of multiple data messages and to use a second subband of the set of multiple subbands to communicate a second quantity of the set of multiple data messages. In some examples, a third codepoint of the field indicates the UE to use the second subband of the set of multiple subbands to communicate the set of multiple data messages.

In some examples, the subband information includes a subband ID. In some examples, the subband ID indicates which subband of the set of multiple subbands the UE is to use to communicate the set of multiple data messages.

In some examples, the subband information includes a set of multiple FDRA fields. In some examples, each FDRA field corresponds to a respective set of the set of multiple data messages and indicates, in conjunction with a time gap between a first data message of the set of multiple data messages and a second data message of the set of multiple data messages, which subband of the set of multiple subbands the UE is to use to communicate the respective set of the set of multiple data messages.

In some examples, the subband information is in accordance with an upper limit quantity of subband switches. In some examples, the upper limit quantity of subband switches is associated with one or both of a capability of the UE or a network protocol. In some examples, the upper limit quantity of subband switches includes zero subband switches, a single subband switch, or two or more subband switches.

In some examples, the subband switching component 1740 is capable of, configured to, or operable to support a means for obtaining an indication of the upper limit quantity of subband switches in accordance with the upper limit quantity of subband switches being associated with the capability of the UE.

In some examples, the subband information indicates the UE to use a first subband of the set of multiple subbands to communicate a first set of data messages of the set of multiple data messages and to use a second subband of the set of multiple subbands to communicate a second set of data messages of the set of multiple data messages. In some examples, a time domain order of the first set of data messages and the second set of data messages is in accordance with a scheduling expectation that there is a single subband switch across the set of multiple data messages.

In some examples, the resource allocation information associated with the set of multiple data messages is at least in part associated with an FDRA field. In some examples, an interpretation of the FDRA field is in accordance with the subband information.

In some examples, the subband information indicates the UE to use a first subband of the set of multiple subbands to communicate a first data message of the set of multiple data messages and to use a second subband of the set of multiple subbands to communicate a second data message of the set of multiple data messages. In some examples, the interpretation of the FDRA field is a first interpretation to obtain a first FDRA associated with the first data message, the first interpretation associated with the first subband. In some examples, the interpretation of the FDRA field is a second interpretation to obtain a second FDRA associated with the second data message, the second interpretation associated with the second subband.

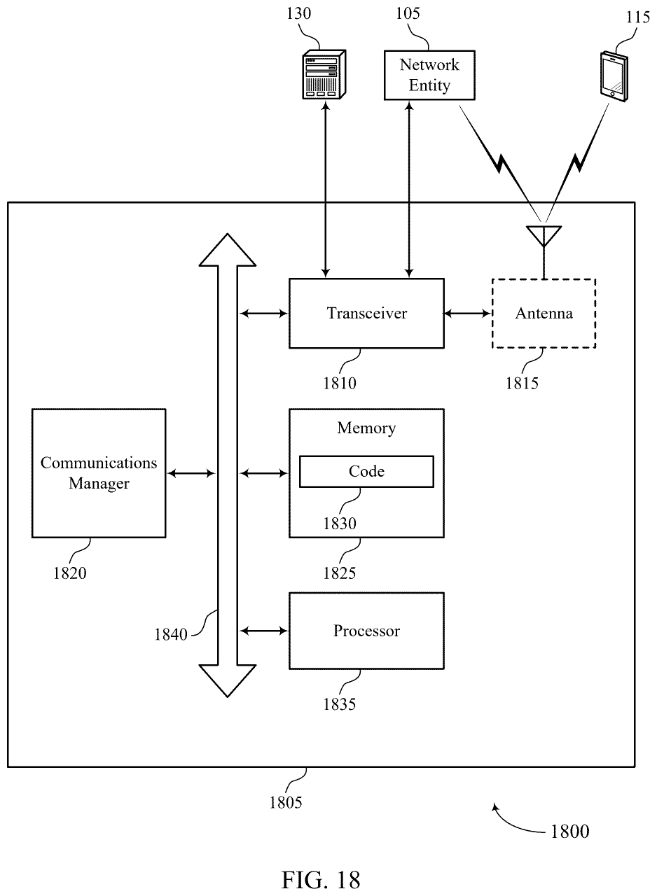

FIG. 18 shows a diagram of a system 1800 including a device 1805 that supports scheduling multiple data messages with light adaptation between subbands of an active BWP using a single DCI message. The device 1805 may be an example of or include components of a device 1505, a device 1605, or a network entity 105 as described herein. The device 1805 may communicate with other network devices or network equipment such as one or more of the network entities 105, UEs 115, or any combination thereof. The communications may include communications over one or more wired interfaces, over one or more wireless interfaces, or any combination thereof. The device 1805 may include components that support outputting and obtaining communications, such as a communications manager 1820, a transceiver 1810, one or more antennas 1815, at least one memory 1825, code 1830, and at least one processor 1835. These components may be in electronic communication or otherwise coupled (such as operatively, communicatively, functionally, electronically, electrically) via one or more buses (such as a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (such as concurrently). The transceiver 1810 may also include a modem to modulate signals, to provide the modulated signals for transmission (such as by one or more antennas 1815, by a wired transmitter), to receive modulated signals (such as from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or one or more memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or one or more memory components (such as the at least one processor 1835, the at least one memory 1825, or both), may be included in a chip or chip assembly that is installed in the device 1805. In some examples, the transceiver 1810 may be operable to support communications via one or more communications links (such as communication link(s) 125, backhaul communication link(s) 120, a midhaul communication link 162, a fronthaul communication link 168).

The at least one memory 1825 may include RAM, ROM, or any combination thereof. The at least one memory 1825 may store computer-readable, computer-executable, or processor-executable code, such as the code 1830. The code 1830 may include instructions that, when executed by one or more of the at least one processor 1835, cause the device 1805 to perform various functions described herein. The code 1830 may be stored in a non-transitory computer-readable medium such as system memory or another type of memory. In some cases, the code 1830 may not be directly executable by a processor of the at least one processor 1835 but may cause a computer (such as when compiled and executed) to perform functions described herein. In some cases, the at least one memory 1825 may include, among other things, a BIOS which may control basic hardware or software operation such as the interaction with peripheral components or devices. In some examples, the at least one processor 1835 may include multiple processors and the at least one memory 1825 may include multiple memories. One or more of the multiple processors may be coupled with one or more of the multiple memories which may, individually or collectively, be configured to perform various functions herein (for example, as part of a processing system).

The at least one processor 1835 may include one or more intelligent hardware devices (such as one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1835 may be configured to operate a memory array using a memory controller. In some other cases, a memory controller may be integrated into one or more of the at least one processor 1835. The at least one processor 1835 may be configured to execute computer-readable instructions stored in a memory (such as one or more of the at least one memory 1825) to cause the device 1805 to perform various functions (such as functions or tasks supporting scheduling multiple data messages with light adaptation between subbands of an active BWP using a single DCI message). For example, the device 1805 or a component of the device 1805 may include at least one processor 1835 and at least one memory 1825 coupled with one or more of the at least one processor 1835, the at least one processor 1835 and the at least one memory 1825 configured to perform various functions described herein. The at least one processor 1835 may be an example of a cloud-computing platform (such as one or more physical nodes and supporting software such as operating systems, virtual machines, or container instances) that may host the functions (such as by executing code 1830) to perform the functions of the device 1805. The at least one processor 1835 may be any one or more suitable processors capable of executing scripts or instructions of one or more software programs stored in the device 1805 (such as within one or more of the at least one memory 1825).

In some examples, the at least one processor 1835 may include multiple processors and the at least one memory 1825 may include multiple memories. One or more of the multiple processors may be coupled with one or more of the multiple memories, which may, individually or collectively, be configured to perform various functions herein. In some examples, the at least one processor 1835 may be a component of a processing system, which may refer to a system (such as a series) of machines, circuitry (including, for example, one or both of processor circuitry (which may include the at least one processor 1835) and memory circuitry (which may include the at least one memory 1825)), or components, that receives or obtains inputs and processes the inputs to produce, generate, or obtain a set of outputs. The processing system may be configured to perform one or more of the functions described herein. For example, the at least one processor 1835 or a processing system including the at least one processor 1835 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code stored in the at least one memory 1825 or otherwise, to perform one or more of the functions described herein. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

In some examples, a bus 1840 may support communications of (such as within) a protocol layer of a protocol stack. In some examples, a bus 1840 may support communications associated with a logical channel of a protocol stack (such as between protocol layers of a protocol stack), which may include communications performed within a component of the device 1805, or between different components of the device 1805 that may be co-located or located in different locations (such as where the device 1805 may refer to a system in which one or more of the communications manager 1820, the transceiver 1810, the at least one memory 1825, the code 1830, and the at least one processor 1835 may be located in one of the different components or divided between different components).

In some examples, the communications manager 1820 may manage aspects of communications with a core network 130 (such as via one or more wired or wireless backhaul links). For example, the communications manager 1820 may manage the transfer of data communications for client devices, such as one or more UEs 115. In some examples, the communications manager 1820 may manage communications with one or more other network entities 105 and may include a controller or scheduler for controlling communications with UEs 115 (such as in cooperation with the one or more other network devices). In some examples, the communications manager 1820 may support an X2 interface within an LTE/LTE-A wireless communications network technology to provide communication between network entities 105.

The communications manager 1820 may support wireless communications in accordance with examples as disclosed herein. For example, the communications manager 1820 is capable of, configured to, or operable to support a means for outputting first configuration information indicative of a set of parameters associated with an active BWP of a UE and, as part of the first configuration information, second configuration information indicative of a set of multiple subbands within the active BWP, the set of multiple subbands including different valid quantities of PRBs. The communications manager 1820 is capable of, configured to, or operable to support a means for outputting a DCI message that includes resource allocation information associated with a set of multiple data messages and includes subband information indicative of which subband of the set of multiple subbands the UE is to use to communicate each data message of the set of multiple data messages. The communications manager 1820 is capable of, configured to, or operable to support a means for communicating the set of multiple data messages using at least one subband of the set of multiple subbands in accordance with the resource allocation information and the subband information.

By including or configuring the communications manager 1820 in accordance with examples as described herein, the device 1805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1820 may be configured to perform various operations (such as receiving, obtaining, monitoring, outputting, transmitting) using or otherwise in cooperation with the transceiver 1810, the one or more antennas 1815 (such as where applicable), or any combination thereof. Although the communications manager 1820 is illustrated as a separate component, in some examples, one or more functions described with reference to the communications manager 1820 may be supported by or performed by the transceiver 1810, one or more of the at least one processor 1835, one or more of the at least one memory 1825, the code 1830, or any combination thereof (for example, by a processing system including at least a portion of the at least one processor 1835, the at least one memory 1825, the code 1830, or any combination thereof). For example, the code 1830 may include instructions executable by one or more of the at least one processor 1835 to cause the device 1805 to perform various aspects of scheduling multiple data messages with light adaptation between subbands of an active BWP using a single DCI message as described herein, or the at least one processor 1835 and the at least one memory 1825 may be otherwise configured to, individually or collectively, perform or support such operations.

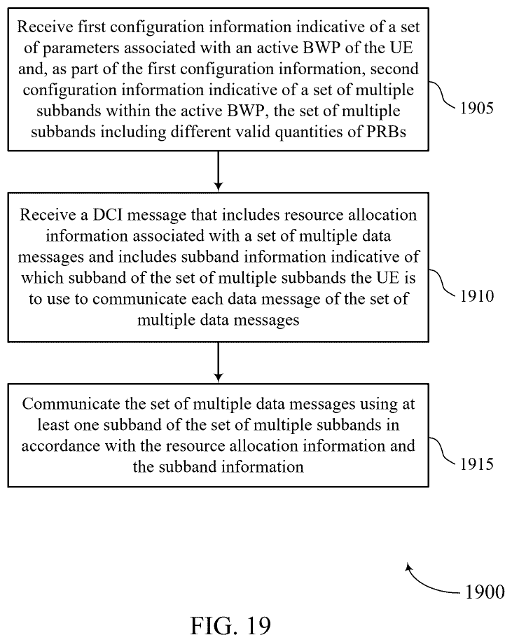

FIG. 19 shows a flowchart illustrating a method 1900 that supports scheduling multiple data messages with light adaptation between subbands of an active BWP using a single DCI message. The operations of the method 1900 may be implemented by a UE or its components as described herein. For example, the operations of the method 1900 may be performed by a UE 115 as described with reference to FIGS. 1-14. In some examples, a UE may execute a set of instructions to control the functional elements of the UE to perform the described functions. Additionally, or alternatively, the UE may perform aspects of the described functions using special-purpose hardware.

At 1905, the method may include receiving first configuration information indicative of a set of parameters associated with an active BWP of the UE and, as part of the first configuration information, second configuration information indicative of a set of multiple subbands within the active BWP, the set of multiple subbands including different valid quantities of PRBs. The operations of 1905 may be performed in accordance with examples as disclosed herein. In some examples, aspects of the operations of 1905 may be performed by a BWP configuration component 1325 as described with reference to FIG. 13.

At 1910, the method may include receiving a DCI message that includes resource allocation information associated with a set of multiple data messages and includes subband information indicative of which subband of the set of multiple subbands the UE is to use to communicate each data message of the set of multiple data messages. The operations of 1910 may be performed in accordance with examples as disclosed herein. In some examples, aspects of the operations of 1910 may be performed by a DCI reception component 1330 as described with reference to FIG. 13.

At 1915, the method may include communicating the set of multiple data messages using at least one subband of the set of multiple subbands in accordance with the resource allocation information and the subband information. The operations of 1915 may be performed in accordance with examples as disclosed herein. In some examples, aspects of the operations of 1915 may be performed by a data communication component 1335 as described with reference to FIG. 13.

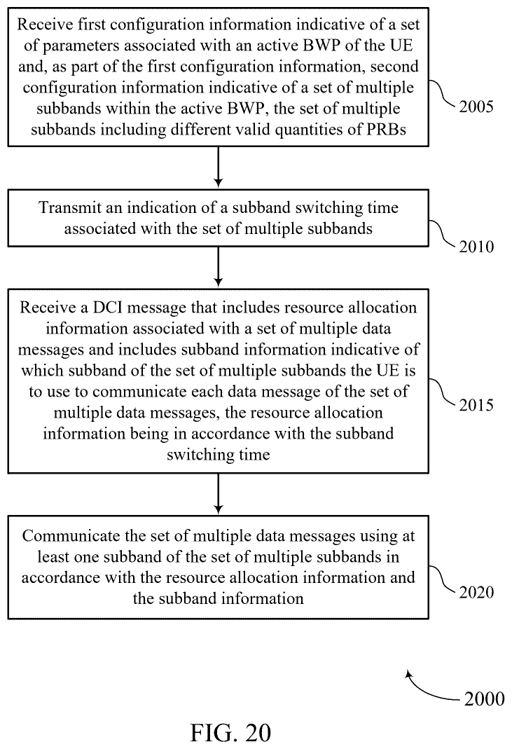

FIG. 20 shows a flowchart illustrating a method 2000 that supports scheduling multiple data messages with light adaptation between subbands of an active BWP using a single DCI message. The operations of the method 2000 may be implemented by a UE or its components as described herein. For example, the operations of the method 2000 may be performed by a UE 115 as described with reference to FIGS. 1-14. In some examples, a UE may execute a set of instructions to control the functional elements of the UE to perform the described functions. Additionally, or alternatively, the UE may perform aspects of the described functions using special-purpose hardware.

At 2005, the method may include receiving first configuration information indicative of a set of parameters associated with an active BWP of the UE and, as part of the first configuration information, second configuration information indicative of a set of multiple subbands within the active BWP, the set of multiple subbands including different valid quantities of PRBs. The operations of 2005 may be performed in accordance with examples as disclosed herein. In some examples, aspects of the operations of 2005 may be performed by a BWP configuration component 1325 as described with reference to FIG. 13.

At 2010, the method may include transmitting an indication of a subband switching time associated with the set of multiple subbands. The operations of 2010 may be performed in accordance with examples as disclosed herein. In some examples, aspects of the operations of 2010 may be performed by a subband switching component 1340 as described with reference to FIG. 13.

At 2015, the method may include receiving a DCI message that includes resource allocation information associated with a set of multiple data messages and includes subband information indicative of which subband of the set of multiple subbands the UE is to use to communicate each data message of the set of multiple data messages, the resource allocation information being in accordance with the subband switching time. The operations of 2015 may be performed in accordance with examples as disclosed herein. In some examples, aspects of the operations of 2015 may be performed by a DCI reception component 1330 as described with reference to FIG. 13.

At 2020, the method may include communicating the set of multiple data messages using at least one subband of the set of multiple subbands in accordance with the resource allocation information and the subband information. The operations of 2020 may be performed in accordance with examples as disclosed herein. In some examples, aspects of the operations of 2020 may be performed by a data communication component 1335 as described with reference to FIG. 13.

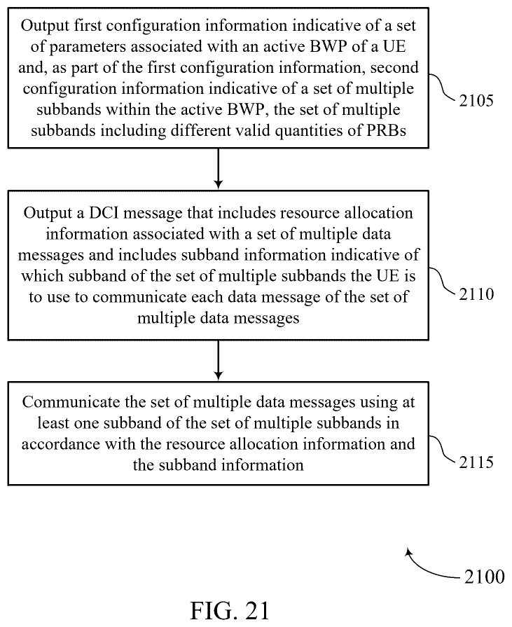

FIG. 21 shows a flowchart illustrating a method 2100 that supports scheduling multiple data messages with light adaptation between subbands of an active BWP using a single DCI message. The operations of the method 2100 may be implemented by a network entity or its components as described herein. For example, the operations of the method 2100 may be performed by a network entity as described with reference to FIGS. 1-10 and 15-18. In some examples, a network entity may execute a set of instructions to control the functional elements of the network entity to perform the described functions. Additionally, or alternatively, the network entity may perform aspects of the described functions using special-purpose hardware.

At 2105, the method may include outputting first configuration information indicative of a set of parameters associated with an active BWP of a UE and, as part of the first configuration information, second configuration information indicative of a set of multiple subbands within the active BWP, the set of multiple subbands including different valid quantities of PRBs. The operations of 2105 may be performed in accordance with examples as disclosed herein. In some examples, aspects of the operations of 2105 may be performed by a BWP configuration component 1725 as described with reference to FIG. 17.

At 2110, the method may include outputting a DCI message that includes resource allocation information associated with a set of multiple data messages and includes subband information indicative of which subband of the set of multiple subbands the UE is to use to communicate each data message of the set of multiple data messages. The operations of 2110 may be performed in accordance with examples as disclosed herein. In some examples, aspects of the operations of 2110 may be performed by a DCI transmission component 1730 as described with reference to FIG. 17.

At 2115, the method may include communicating the set of multiple data messages using at least one subband of the set of multiple subbands in accordance with the resource allocation information and the subband information. The operations of 2115 may be performed in accordance with examples as disclosed herein. In some examples, aspects of the operations of 2115 may be performed by a data communication component 1735 as described with reference to FIG. 17.

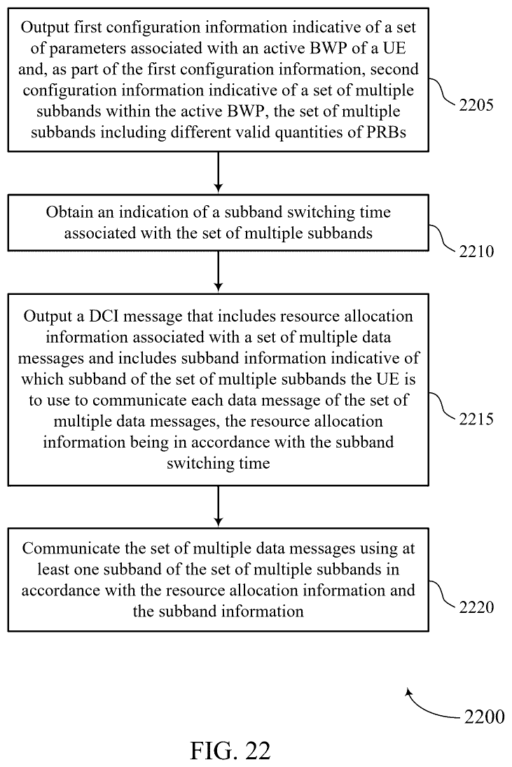

FIG. 22 shows a flowchart illustrating a method 2200 that supports scheduling multiple data messages with light adaptation between subbands of an active BWP using a single DCI message. The operations of the method 2200 may be implemented by a network entity or its components as described herein. For example, the operations of the method 2200 may be performed by a network entity as described with reference to FIGS. 1-10 and 15-18. In some examples, a network entity may execute a set of instructions to control the functional elements of the network entity to perform the described functions. Additionally, or alternatively, the network entity may perform aspects of the described functions using special-purpose hardware.

At 2205, the method may include outputting first configuration information indicative of a set of parameters associated with an active BWP of a UE and, as part of the first configuration information, second configuration information indicative of a set of multiple subbands within the active BWP, the set of multiple subbands including different valid quantities of PRBs. The operations of 2205 may be performed in accordance with examples as disclosed herein. In some examples, aspects of the operations of 2205 may be performed by a BWP configuration component 1725 as described with reference to FIG. 17.

At 2210, the method may include obtaining an indication of a subband switching time associated with the set of multiple subbands. The operations of 2210 may be performed in accordance with examples as disclosed herein. In some examples, aspects of the operations of 2210 may be performed by a subband switching component 1740 as described with reference to FIG. 17.

At 2215, the method may include outputting a DCI message that includes resource allocation information associated with a set of multiple data messages and includes subband information indicative of which subband of the set of multiple subbands the UE is to use to communicate each data message of the set of multiple data messages, the resource allocation information being in accordance with the subband switching time. The operations of 2215 may be performed in accordance with examples as disclosed herein. In some examples, aspects of the operations of 2215 may be performed by a DCI transmission component 1730 as described with reference to FIG. 17.

At 2220, the method may include communicating the set of multiple data messages using at least one subband of the set of multiple subbands in accordance with the resource allocation information and the subband information. The operations of 2220 may be performed in accordance with examples as disclosed herein. In some examples, aspects of the operations of 2220 may be performed by a data communication component 1735 as described with reference to FIG. 17.

The following provides an overview of aspects of the present disclosure:

Aspect 1: A method for wireless communication at a UE, comprising: receiving first configuration information indicative of a set of parameters associated with an active bandwidth part of the UE and, as part of the first configuration information, second configuration information indicative of a plurality of subbands within the active bandwidth part, the plurality of subbands comprising different valid quantities of PRBs; receiving a DCI message that comprises resource allocation information associated with a plurality of data messages and comprises subband information indicative of which subband of the plurality of subbands the UE is to use to communicate each data message of the plurality of data messages; and communicating the plurality of data messages using at least one subband of the plurality of subbands in accordance with the resource allocation information and the subband information.

Aspect 2: The method of aspect 1, further comprising: transmitting an indication of a subband switching time associated with the plurality of subbands, the resource allocation information associated with the plurality of data messages being in accordance with the subband switching time.

Aspect 3: The method of aspect 2, wherein the subband switching time is associated with a capability of the UE.

Aspect 4: The method of any of aspects 2-3, wherein the plurality of subbands comprises a first subband and a second subband; the first subband comprises a first valid quantity of PRBs and the second subband comprises a second valid quantity of PRBs that is greater than the first valid quantity of PRBs; and the subband switching time defines a lower limit amount of time between a first data message of the plurality of data messages that uses the first subband and a second data message of the plurality of data messages that uses the second subband.

Aspect 5: The method of any of aspects 2-4, wherein the plurality of subbands comprises a first subband and a second subband that are non-overlapping; the first subband comprises a first valid quantity of PRBs and the second subband comprises a second valid quantity of PRBs that is greater than the first valid quantity of PRBs; and the subband switching time defines a lower limit amount of time between a first data message of the plurality of data messages that uses the second subband and a second data message of the plurality of data messages that uses the first subband.

Aspect 6: The method of any of aspects 2-5, wherein the DCI message indicates a time gap between a first data message of the plurality of data messages and a second data message of the plurality of data messages, and the time gap is in accordance with the subband switching time.

Aspect 7: The method of any of aspects 1-6, wherein the subband information comprises a bitmap, and each bit of the bitmap corresponds to a respective data message of the plurality of data messages and indicates which subband of the plurality of subbands the UE is to use to communicate the respective data message.

Aspect 8: The method of aspect 7, wherein a first bit value indicates the UE to use a first subband of the plurality of subbands to communicate a corresponding data message and a second bit value indicates the UE to use a second subband of the plurality of subbands to communicate the corresponding data message.

Aspect 9: The method of any of aspects 1-8, wherein the subband information comprises a field, and different codepoints of the field indicate different subband patterns the UE is to use to communicate the plurality of data messages.

Aspect 10: The method of aspect 9, wherein a first codepoint of the field indicates the UE to use a first subband of the plurality of subbands to communicate the plurality of data messages; a second codepoint of the field indicates the UE to use the first subband of the plurality of subbands to communicate a first quantity of the plurality of data messages and to use a second subband of the plurality of subbands to communicate a second quantity of the plurality of data messages; and a third codepoint of the field indicates the UE to use the second subband of the plurality of subbands to communicate the plurality of data messages.

Aspect 11: The method of any of aspects 1-10, wherein the subband information comprises a subband ID, and the subband ID indicates which subband of the plurality of subbands the UE is to use to communicate the plurality of data messages.

Aspect 12: The method of any of aspects 1-11, wherein the subband information comprises a plurality of FDRA fields, and each FDRA field corresponds to a respective set of the plurality of data messages and indicates, in conjunction with a time gap between a first data message of the plurality of data messages and a second data message of the plurality of data messages, which subband of the plurality of subbands the UE is to use to communicate the respective set of the plurality of data messages.

Aspect 13: The method of any of aspects 1-12, wherein the subband information is in accordance with an upper limit quantity of subband switches, and the upper limit quantity of subband switches is associated with one or both of a capability of the UE or a network protocol.

Aspect 14: The method of aspect 13, wherein the upper limit quantity of subband switches comprises zero subband switches, a single subband switch, or two or more subband switches.

Aspect 15: The method of any of aspects 13-14, further comprising: transmitting an indication of the upper limit quantity of subband switches in accordance with the upper limit quantity of subband switches being associated with the capability of the UE.

Aspect 16: The method of any of aspects 1-15, wherein the subband information indicates the UE to use a first subband of the plurality of subbands to communicate a first set of data messages of the plurality of data messages and to use a second subband of the plurality of subbands to communicate a second set of data messages of the plurality of data messages; and a time domain order of the first set of data messages and the second set of data messages is in accordance with a scheduling expectation that there is a single subband switch across the plurality of data messages.

Aspect 17: The method of any of aspects 1-16, wherein the resource allocation information associated with the plurality of data messages is at least in part associated with an FDRA field, and an interpretation of the FDRA field is in accordance with the subband information.

Aspect 18: The method of aspect 17, wherein the subband information indicates the UE to use a first subband of the plurality of subbands to communicate a first data message of the plurality of data messages and to use a second subband of the plurality of subbands to communicate a second data message of the plurality of data messages; the interpretation of the FDRA field is a first interpretation to obtain a first FDRA associated with the first data message, the first interpretation associated with the first subband; and the interpretation of the FDRA field is a second interpretation to obtain a second FDRA associated with the second data message, the second interpretation associated with the second subband.

Aspect 19: A method for wireless communication at a network entity, comprising: outputting first configuration information indicative of a set of parameters associated with an active bandwidth part of a UE and, as part of the first configuration information, second configuration information indicative of a plurality of subbands within the active bandwidth part, the plurality of subbands comprising different valid quantities of PRBs; outputting a DCI message that comprises resource allocation information associated with a plurality of data messages and comprises subband information indicative of which subband of the plurality of subbands the UE is to use to communicate each data message of the plurality of data messages; and communicating the plurality of data messages using at least one subband of the plurality of subbands in accordance with the resource allocation information and the subband information.

Aspect 20: The method of aspect 19, further comprising: obtaining an indication of a subband switching time associated with the plurality of subbands, the resource allocation information associated with the plurality of data messages being in accordance with the subband switching time.

Aspect 21: The method of aspect 20, wherein the subband switching time is associated with a capability of the UE.

Aspect 22: The method of any of aspects 20-21, wherein the plurality of subbands comprises a first subband and a second subband; the first subband comprises a first valid quantity of PRBs and the second subband comprises a second valid quantity of PRBs that is greater than the first valid quantity of PRBs; and the subband switching time defines a lower limit amount of time between a first data message of the plurality of data messages that uses the first subband and a second data message of the plurality of data messages that uses the second subband.

Aspect 23: The method of any of aspects 20-22, wherein the plurality of subbands comprises a first subband and a second subband that are non-overlapping; the first subband comprises a first valid quantity of PRBs and the second subband comprises a second valid quantity of PRBs that is greater than the first valid quantity of PRBs; and the subband switching time defines a lower limit amount of time between a first data message of the plurality of data messages that uses the second subband and a second data message of the plurality of data messages that uses the first subband.

Aspect 24: The method of any of aspects 20-23, wherein the DCI message indicates a time gap between a first data message of the plurality of data messages and a second data message of the plurality of data messages, and the time gap is in accordance with the subband switching time.

Aspect 25: The method of any of aspects 19-24, wherein the subband information comprises a bitmap, and each bit of the bitmap corresponds to a respective data message of the plurality of data messages and indicates which subband of the plurality of subbands the UE is to use to communicate the respective data message.

Aspect 26: The method of aspect 25, wherein a first bit value indicates the UE to use a first subband of the plurality of subbands to communicate a corresponding data message and a second bit value indicates the UE to use a second subband of the plurality of subbands to communicate the corresponding data message.

Aspect 27: The method of any of aspects 19-26, wherein the subband information comprises a field, and different codepoints of the field indicate different subband patterns the UE is to use to communicate the plurality of data messages.

Aspect 28: The method of aspect 27, wherein a first codepoint of the field indicates the UE to use a first subband of the plurality of subbands to communicate the plurality of data messages; a second codepoint of the field indicates the UE to use the first subband of the plurality of subbands to communicate a first quantity of the plurality of data messages and to use a second subband of the plurality of subbands to communicate a second quantity of the plurality of data messages; and a third codepoint of the field indicates the UE to use the second subband of the plurality of subbands to communicate the plurality of data messages.

Aspect 29: The method of any of aspects 19-28, wherein the subband information comprises a subband ID, and the subband ID indicates which subband of the plurality of subbands the UE is to use to communicate the plurality of data messages.

Aspect 30: The method of any of aspects 19-29, wherein the subband information comprises a plurality of FDRA fields, and each FDRA field corresponds to a respective set of the plurality of data messages and indicates, in conjunction with a time gap between a first data message of the plurality of data messages and a second data message of the plurality of data messages, which subband of the plurality of subbands the UE is to use to communicate the respective set of the plurality of data messages.

Aspect 31: The method of any of aspects 19-30, wherein the subband information is in accordance with an upper limit quantity of subband switches, and the upper limit quantity of subband switches is associated with one or both of a capability of the UE or a network protocol.

Aspect 32: The method of aspect 31, wherein the upper limit quantity of subband switches comprises zero subband switches, a single subband switch, or two or more subband switches.

Aspect 33: The method of any of aspects 31-32, further comprising: obtaining an indication of the upper limit quantity of subband switches in accordance with the upper limit quantity of subband switches being associated with the capability of the UE.

Aspect 34: The method of any of aspects 19-33, wherein the subband information indicates the UE to use a first subband of the plurality of subbands to communicate a first set of data messages of the plurality of data messages and to use a second subband of the plurality of subbands to communicate a second set of data messages of the plurality of data messages; and a time domain order of the first set of data messages and the second set of data messages is in accordance with a scheduling expectation that there is a single subband switch across the plurality of data messages.

Aspect 35: The method of any of aspects 19-34, wherein the resource allocation information associated with the plurality of data messages is at least in part associated with an FDRA field, and an interpretation of the FDRA field is in accordance with the subband information.

Aspect 36: The method of aspect 35, wherein the subband information indicates the UE to use a first subband of the plurality of subbands to communicate a first data message of the plurality of data messages and to use a second subband of the plurality of subbands to communicate a second data message of the plurality of data messages; the interpretation of the FDRA field is a first interpretation to obtain a first FDRA associated with the first data message, the first interpretation associated with the first subband; and the interpretation of the FDRA field is a second interpretation to obtain a second FDRA associated with the second data message, the second interpretation associated with the second subband.

Aspect 37: An apparatus for wireless communication at a UE, comprising a processing system that includes processor circuitry and memory circuitry that stores code, the processing system configured to cause the apparatus to perform a method of any of aspects 1-18.

Aspect 38: An apparatus for wireless communication at a UE, comprising at least one means for performing a method of any of aspects 1-18.

Aspect 39: A non-transitory computer-readable medium storing code for wireless communications, the code comprising instructions executable by one or more processors to perform a method of any of aspects 1-18.

Aspect 40: An apparatus for wireless communication at a network entity, comprising a processing system that includes processor circuitry and memory circuitry that stores code, the processing system configured to cause the apparatus to perform a method of any of aspects 19-36.

Aspect 41: An apparatus for wireless communication at a network entity, comprising at least one means for performing a method of any of aspects 19-36.

Aspect 42: A non-transitory computer-readable medium storing code for wireless communications, the code comprising instructions executable by one or more processors to perform a method of any of aspects 19-36.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (such as a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrases “based at least in part on,” “associated with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processing system that includes processor circuitry and memory circuitry that stores code, the processing system configured to cause the apparatus to:
receive first configuration information indicative of a set of parameters associated with an active bandwidth part of the UE and, as part of the first configuration information, second configuration information indicative of a plurality of subbands within the active bandwidth part, the plurality of subbands comprising different valid quantities of physical resource blocks;
receive a downlink control information message that comprises resource allocation information associated with a plurality of data messages and comprises subband information indicative of which subband of the plurality of subbands the UE is to use to communicate each data message of the plurality of data messages; and
communicate the plurality of data messages using at least one subband of the plurality of subbands in accordance with the resource allocation information and the subband information.

2. The apparatus of claim 1, wherein the processing system is further configured to cause the apparatus to:
transmit an indication of a subband switching time associated with the plurality of subbands, the resource allocation information associated with the plurality of data messages being in accordance with the subband switching time.

3. The apparatus of claim 2, wherein the subband switching time is associated with a capability of the apparatus.

4. The apparatus of claim 2, wherein:
the plurality of subbands comprises a first subband and a second subband;
the first subband comprises a first valid quantity of physical resource blocks and the second subband comprises a second valid quantity of physical resource blocks that is greater than the first valid quantity of physical resource blocks; and
the subband switching time defines a lower limit amount of time between a first data message of the plurality of data messages that uses the first subband and a second data message of the plurality of data messages that uses the second subband.

5. The apparatus of claim 2, wherein:
the plurality of subbands comprises a first subband and a second subband that are non-overlapping;
the first subband comprises a first valid quantity of physical resource blocks and the second subband comprises a second valid quantity of physical resource blocks that is greater than the first valid quantity of physical resource blocks; and
the subband switching time defines a lower limit amount of time between a first data message of the plurality of data messages that uses the second subband and a second data message of the plurality of data messages that uses the first subband.

6. The apparatus of claim 2, wherein:
the downlink control information message indicates a time gap between a first data message of the plurality of data messages and a second data message of the plurality of data messages; and
the time gap is in accordance with the subband switching time.

7. The apparatus of claim 1, wherein:
the subband information comprises a bitmap; and
each bit of the bitmap corresponds to a respective data message of the plurality of data messages and indicates which subband of the plurality of subbands the UE is to use to communicate the respective data message.

8. The apparatus of claim 7, wherein a first bit value indicates the UE to use a first subband of the plurality of subbands to communicate a corresponding data message and a second bit value indicates the UE to use a second subband of the plurality of subbands to communicate the corresponding data message.

9. The apparatus of claim 1, wherein:
the subband information comprises a field; and
different codepoints of the field indicate different subband patterns the UE is to use to communicate the plurality of data messages.

10. The apparatus of claim 9, wherein:
a first codepoint of the field indicates the UE to use a first subband of the plurality of subbands to communicate the plurality of data messages;
a second codepoint of the field indicates the UE to use the first subband of the plurality of subbands to communicate a first quantity of the plurality of data messages and to use a second subband of the plurality of subbands to communicate a second quantity of the plurality of data messages; and
a third codepoint of the field indicates the UE to use the second subband of the plurality of subbands to communicate the plurality of data messages.

11. The apparatus of claim 1, wherein:
the subband information comprises a subband identifier; and
the subband identifier indicates which subband of the plurality of subbands the UE is to use to communicate the plurality of data messages.

12. The apparatus of claim 1, wherein:
the subband information comprises a plurality of frequency domain resource allocation fields; and
each frequency domain resource allocation field corresponds to a respective set of the plurality of data messages and indicates, in conjunction with a time gap between a first data message of the plurality of data messages and a second data message of the plurality of data messages, which subband of the plurality of subbands the UE is to use to communicate the respective set of the plurality of data messages.

13. A method for wireless communication at a user equipment (UE), comprising:
receiving first configuration information indicative of a set of parameters associated with an active bandwidth part of the UE and, as part of the first configuration information, second configuration information indicative of a plurality of subbands within the active bandwidth part, the plurality of subbands comprising different valid quantities of physical resource blocks;
receiving a downlink control information message that comprises resource allocation information associated with a plurality of data messages and comprises subband information indicative of which subband of the plurality of subbands the UE is to use to communicate each data message of the plurality of data messages; and
communicating the plurality of data messages using at least one subband of the plurality of subbands in accordance with the resource allocation information and the subband information.

14. The method of claim 13, wherein:
the subband information is in accordance with an upper limit quantity of subband switches; and
the upper limit quantity of subband switches is associated with one or both of a capability of the UE or a network protocol.

15. The method of claim 14, further comprising:
transmitting an indication of the upper limit quantity of subband switches in accordance with the upper limit quantity of subband switches being associated with the capability of the UE.

16. The method of claim 13, wherein:
the subband information indicates the UE to use a first subband of the plurality of subbands to communicate a first set of data messages of the plurality of data messages and to use a second subband of the plurality of subbands to communicate a second set of data messages of the plurality of data messages; and
a time domain order of the first set of data messages and the second set of data messages is in accordance with a scheduling expectation that there is a single subband switch across the plurality of data messages.

17. The method of claim 13, wherein:
the resource allocation information associated with the plurality of data messages is at least in part associated with a frequency domain resource allocation field; and
an interpretation of the frequency domain resource allocation field is in accordance with the subband information.

18. The method of claim 17, wherein:
the subband information indicates the UE to use a first subband of the plurality of subbands to communicate a first data message of the plurality of data messages and to use a second subband of the plurality of subbands to communicate a second data message of the plurality of data messages;
the interpretation of the frequency domain resource allocation field is a first interpretation to obtain a first frequency domain resource allocation associated with the first data message, the first interpretation associated with the first subband; and
the interpretation of the frequency domain resource allocation field is a second interpretation to obtain a second frequency domain resource allocation associated with the second data message, the second interpretation associated with the second subband.

19. An apparatus for wireless communication at a user equipment (UE), comprising:
means for receiving first configuration information indicative of a set of parameters associated with an active bandwidth part of the UE and, as part of the first configuration information, second configuration information indicative of a plurality of subbands within the active bandwidth part, the plurality of subbands comprising different valid quantities of physical resource blocks;
means for receiving a downlink control information message that comprises resource allocation information associated with a plurality of data messages and comprises subband information indicative of which subband of the plurality of subbands the UE is to use to communicate each data message of the plurality of data messages; and
means for communicating the plurality of data messages using at least one subband of the plurality of subbands in accordance with the resource allocation information and the subband information.

20. The apparatus of claim 19, further comprising:
means for transmitting an indication of a subband switching time associated with the plurality of subbands, the resource allocation information associated with the plurality of data messages being in accordance with the subband switching time.
